(19) United States
(12) Patent Application Publication
(10) Pub. No.: US 2023/0411724 A1
(43) Pub. Date: Dec. 21, 2023

(54) BATTERY RECYCLING

(71) Applicant: THE UNIVERSITY OF BIRMINGHAM, Birmingham West Midlands (GB)

(72) Inventors: Laura Louise Driscoll, Edgbaston (GB); Peter Raymond Slater, Birmingham West Midlands (GB); Paul Alexander Anderson, Birmingham West Midlands (GB)

(21) Appl. No.: 18/250,136

(22) PCT Filed: Oct. 20, 2021
(86) PCT No.: PCT/GB2021/052701

§ 371 Date: Apr. 21, 2023

(30) Foreign Application Priority Data
Oct. 21, 2020 (GB) 2016722.7

(51) Int. Cl. H01M 10/54; C22B 47/00; C22B 7/00; H01M 4/525; H01M 4/505; H01M 4/04

(52) U.S. Cl. CPC H01M 10/54; C22B 47/0063; C22B 7/007; H01M 4/525; H01M 4/505; H01M 4/0471

(57) ABSTRACT

A method (2800) of selectively leaching one or more manganese-containing phases from a mixed-phase battery electrode material comprises treating (2802) the mixed-phase battery electrode material with a solution of an acid, the acid acting as both a leaching agent and a reducing agent, so as to form a manganese-containing leachate whilst leaving at least one phase of the battery electrode material unleached, wherein the acid has a pKa greater than or equal to −2. Either or both of the leachate and the remaining electrode material may then be regenerated (2806, 2808).

The invention relates to the recycling and/or regeneration of battery materials, in particular electrode materials. The process described may be of particular utility for blended (multi-phase) cathode materials of a Na-ion or Li-ion battery. In particular, but not exclusively, the method may comprise phase-selective leaching of one or more phases from a Na-ion or Li-ion battery electrode material, and/or optionally the regeneration or reformation of one or more of a leached phase and a remaining, unleached, phase so as to generate one or more materials suitable for reuse in, or as, a Na—ion or Li-ion battery electrode material.

In order to tackle climate change, many large economies are attempting to develop strategies to reduce emissions; for example, the UK government has set the target of becoming net zero by 2050. In order to achieve such targets, electric vehicles are seen as a key part of the solution as emissions over the lifetime of an electric vehicle are much reduced compared to typical petrol and diesel vehicles. Batteries need to be recycled once they come to the end of their service lives. However, current figures suggest a significant discrepancy between the number of Li-ion batteries sold and those currently recycled. This not only causes issues regarding the leaching of toxic elements into the environment but also has a number of safety implications if the batteries are mistreated (e.g. toxic gas release, thermal runaway). However, if recycled correctly, these batteries could prove to be an untapped resource for key strategic elements such as Li, Mn, Co and Ni. Therefore there is interest in recovering these key elements, especially as demand for resources increases.

At present, two major routes are implemented for recycling of batteries; pyrometallurgy and hydrometallurgy. Pyrometallurgy utilises high temperatures to smelt batteries to form an alloy, and this alloy is then treated to recover key metals such as Co, Ni and Mn. An advantage of the technique is that the batteries do not have to be sorted before undergoing the smelting process. However, the process has a number of disadvantages, such as the loss of volatile elements (e.g. Li), the requirement for energy-intensive high temperatures and the limitation that only a relatively small amount of battery scrap can be treated at a given time (see W. Lv, Z. Wang, H. Cao, Y. Sun, Y. Zhang, Z. Sun, A Critical Review and Analysis on the Recycling of Spent Lithium-Ion Batteries, ACS Sustain. Chem. Eng. 6 (2018) 1504-1521. doi:10.1021/acssuschemeng.7b03811). The second route, hydrometallurgy, uses acids/solvents to dissolve battery scrap and to extract key metals by drawing them into solution. Prior to treatment, battery cells (obtained via disassembly of the battery pack) are shredded. Cell casing, separator and current collector are removed, creating a fraction commonly referred to as ‘black mass’, the smallest fraction after sieving, that contains a mixture of anode/cathode materials. The black mass is then chemically treated; often using sulfuric acid as a leaching acid and H₂O₂ as a reducing agent, which has been shown to improve leaching efficiency. Hydrometallurgy routes utilise relatively concentrated mineral acids, which could pose a disposal challenge, as well as requiring comparatively long leaching times. Nonetheless, this route does allow for the recycling of materials through a closed-loop process. A closed-loop or short-loop process aims to regenerate either the original material or to make novel materials through the use of cathode/anode scrap as starting materials.

However, relatively little research has been performed regarding the recycling of blended electrode materials (e.g. as used in Nissan Leaf Gen. 1 cells). A blended cathode contains a combination of two cathode materials which complement each other during operation (e.g. one may act as a stability aid). For example, in the LMO/LO blended system, addition of a layered oxide (LO) (e.g. LiNi_{0.8}Co_{0.2}O₂) reduces Mn dissolution from the (LMO) spinel phase (such dissolution may be completely eliminated once the LO reaches 15 wt. %) and hence preventing a decline in capacity during storage (see T. Numata, C. Amemiya, T. Kumeuchi, Advantages of blending LiNi_{0.8}Co_{0.2}O₂ into Li₁₋ₓMn₂₋ₓO₄ cathodes, 98 (2001) 358-360). The presence of two cathode materials therefore provides some additional challenges to the recycling process; a situation similar to that found if cells sourced from different manufacturers/generations were shredded together, therefore mixing electrode chemistries. The current approach is to dissolve all inorganic components in order to commence recovery/regeneration.

According to a first aspect of the invention, there is provided a method of selectively leaching one or more manganese-containing phases from a mixed-phase battery electrode material, the method comprising:

treating the mixed-phase battery electrode material with a solution of an acid, the acid acting as both a leaching agent and a reducing agent so as to form a manganese-containing leachate whilst leaving at least one phase of the battery electrode material unleached,

wherein the acid has a pKa greater than or equal to −2.

This treatment may therefore exploit the differing solubilities of various metals in acidic conditions to remove predominantly Manganese phases (such as LMO), or other Manganese-containing phases, while leaving behind other phases, such as predominantly Nickel NMC or NCA phases often found in current Li-ion battery cathodes. The mixed phases may be provided by one or more blended cathode materials (i.e. cathodes which comprise multiple phases/cathode materials in a single cathode), and/or by mixing of material from different cathode types and/or sources (accidentally or intentionally). In addition, the approach disclosed herein may be used with pre-delaminated cathode materials, or delamination (e.g. to remove a current collector) may be performed as a part of the process (the acid treatment may facilitate or allow the separation from the current collector from the electrode material, e.g. by etching an aluminium oxide later at the interface). It will be appreciated that delamination of a cathode layer from a current collector layer is not equivalent to leaching of one cathode material from a mixture of cathode materials, but is rather a step likely to be performed prior to implementing the leaching treatment described herein. The approach disclosed herein is therefore applicable to a wide range of input material streams, offering much greater feedstock flexibility than prior techniques.

The method may specifically and selectively leach manganese-containing phases such as LiMn₂O₄(LMO) from blended-material cathodes within minutes. The method may specifically and selectively leach manganese-containing phases with an Mn content of at least 20% of the transition metal content of the phase (mole ratio).

The inventors appreciated that if recycling methodologies could target specific phases, the efficiency of the recycling process for mixed-phase materials could be improved as it would allow the recovery of different materials from the individual cathode materials separately, and so avoid dilution of the individual waste streams. For example, in the case of LMO/NMC or LMO/NCA electrodes (where LMO is Lithium Manganese Oxide, LiMn₂O₄, which may also be referred to as Lithium Manganese Spinel, and NMC is a Nickel Manganese Cobalt Oxide, generally LiNiₓMn_{y}Co_{z}O₂, and NCA is a Nickel Cobalt Aluminium Oxide, generally LiNiₓCo_{y}Al_{z}O₂), a process as described herein could avoid dilution of the NMC waste stream with additional Mn, thus allowing for easier regeneration of the NMC phase.

By contrast, prior art approaches such as that disclosed in CN111621643 (A) dissolve a particular element from a specific electrode material—dissolving lithium in the cited example—instead of removing a particular phase of a mixed-phase cathode material. Embodiments of the present invention instead allow one cathode material (a phase—not just one element) to be removed from a mixture of different cathode materials, leaving one or more cathode materials at least substantially unaffected. Indeed, embodiments of the present invention seek to leave the remaining cathode material(s) intact insofar as possible, for recycling or re-use purposes, so an approach which dissolves lithium from a surface irrespective of the other constituents of the material of that surface goes against the intentions of such embodiments. (Whilst it will be appreciated that a small amount of various species, e.g. lithium, may dissolve from other phases, the embodiments disclosed herein are intended to avoid or minimise that loss.) Further, such prior art approaches only treat one cathode material at a time, removing one element from that selected phase—by contrast, the process of the present application treats one or more phases, such as LMO, selectively and removes that phase/those phases from a cathode mixture of multiple cathode materials, instead of requiring a single-phase feedstock. The selective removal of one phase/of one component oxide material of a cathode provides separate output streams for the two different phases or groups of phases (leached and unleached), with no (or minimal) mixing of constituents of the two. Traditional separation approaches may therefore be unnecessary, so facilitating regeneration or re-use.

Further, lithium has generally been the focus to date, and a different approach is needed for manganese, and indeed for other transition metals, as the chemistry of lithium differs.

The inventors appreciated that careful consideration of the chemistry of the metals involved could provide an improved approach to metal recycling, moving away from the focus on complete dissolution in prior recycling techniques. Additionally, the inventors appreciated that introducing monitoring of the cathode strip (or other cathode material) during treatment, as opposed to simply examining the end product, could allow a more efficient, selective process to be developed.

In particular, the most stable oxidation state of Mn in acidic conditions is M^{II}, i.e. Mn²⁺ (ΔG for the dissolution is notably negative, so the dissolution is likely to be spontaneous), whereas for other metals such as Co and Ni, the ΔG values are less negative/only just negative, and therefore it is likely that further ‘encouragement’ (e.g. more acidic conditions, a longer treatment time, a higher treatment temperature, or the like) would be needed to get those metals into solution.

A selective recycling route is therefore provided, which is highly sought-after for direct recycling approaches—for example, conditions may be selected such that NMC/NCA materials are not delithiated during the leaching step, allowing the material to be reused after separation (this may be especially straight-forward in the case of quality-control-rejected or early lifetime cells). NCA refers to Nickel Cobalt Aluminium oxides, and often to Lithium Nickel Cobalt Aluminium oxides more specifically.

Advantageously, materials which are currently perceived as ‘lower value’ can therefore be removed quickly from either a blended or mixed (such as shredded black mass) waste stream and repurposed while retaining the layered oxide for an alternative regeneration route. For example, in some recycling scenarios, electrodes from different cells and with different chemistries may be mixed together—e.g. a LiFePO₄ cathode from a Lithium Iron Phosphate (LFP) battery may be mixed with an LMO cathode from a different sort of lithium-ion battery if cells with different chemistries are shredded together (either intentionally or unintentionally). It will be appreciated that lithium-ion (and/or sodium-ion) batteries are generally separated from other battery types, but may not be sorted according to the different chemistries within that classification. The approach as described herein may allow for quick processing of even such an electrode mixture, as only the phase(s) with a Mn percentage of at least 20% of the transition metal content are leached, so allowing separation. The remaining phase(s) are at least substantially unaffected, facilitating recycling or re-use of the un-leached materials. This flexibility of the approach may be especially beneficial as manufacturers may not consistently state the exact battery composition. The leaching process allows for a quick way to selectively remove certain phases. The route may have particular applicability to the NMC/NCA phase of many cathodes in particular.

Advantageously, in various embodiments a gravimetric approach can be used to provide a very quick determination as to whether a treatment has been successful, so avoiding the reliance on more complex techniques used previously (e.g. on techniques which require a lot of preparation, such as Inductively Coupled Plasma—ICP—measurements). Gravimetric assessment may be especially beneficial for high through-put processes, in terms of both cost and time savings.

The mixed-phase battery electrode material may be a cathode material. The mixed-phase battery electrode material may be a cathode material from a sodium- and/or lithium-ion battery having a blended cathode. Mixtures of different cathode materials, and indeed of different electrode materials more generally, may be used in other embodiments.

The mixed-phase battery electrode material may comprise a layered oxide material. The layered oxide material may be one of the one or more phases of the battery electrode material which is unleached. The layered oxide material may be the single unleached phase in some embodiments. The layered oxide material may comprise less than 20% Mn, as a percentage of its transition metal content (by number ratio of elements, i.e. mole ratio). The layered oxide material may not contain any manganese in some embodiments.

The layered oxide material may be or comprise NMC or NCA. The layered oxide material may be or comprise doped or undoped NMC, and/or doped or undoped NCA. For example, the layered oxide material may be NMC doped with Aluminium; commonly referred to as NMCA. Magnesium may be present as a dopant in some embodiments.

NMC refers generally to LiNiₓMn_{y}Co_{z}O₂, with the sum of x, y and z being 1, unless specified otherwise. Where a dopant is present (e.g. Aluminium or Magnesium, or indeed additional Lithium), the sum of x, y and z will be slightly smaller than 1, with the dopant making up the remainder. The amount of the dopant is small compared to the sum of x, y and z (for example being less than 15%, optionally less than 10%, and further optionally less than 5%, as a mole percentage of the sum of transition metal plus dopant content, and so generally not listed for clarity). This may be denoted as x+y+z+δ=1, where δ represents the amount of the dopant and δ≤0.15, and optionally δ≤0.10 or 0.05. However, it will be noted that other metal ions, such as sodium, may take the place of the lithium, and/or may be mixed with the lithium. The terminology “XNMC” is used herein to explicitly indicate the optional changing of this metal ion; for example, X may represent Na, Li, or a mixture of the two. Further, it will be appreciated that the metal ion, X, is not present in NMC hydroxides—NiₓMn_{y}Co_{z}(OH)₂.

NCA refers generally to LiNiₓCo_{y}Al_{z}O₂, unless specified otherwise, with the sum of x, y and z being 1. Where a dopant is present (e.g. Manganese or Magnesium, or indeed additional Lithium), the sum of x, y and z will be slightly smaller than 1, with the dopant making up the remainder. However, as for NMC, it will be noted that other metal ions, such as sodium, may take the place of the lithium, and/or may be mixed with the lithium. The terminology “XNCA” is used herein to explicitly indicate the optional changing of this metal ion; for example, X may represent Na, Li, or a mixture of the two. Again, it will be appreciated that the metal ion, X, is not present in NCA hydroxides—NiₓCo_{y}Al_{z}(OH)₂, and that small amounts of one or more dopants may be present, as discussed above.

A more accurate chemical formula may therefore be presented as XNiₓMn_{y}Co_{z}DδO₂ (XNMC) or XNiₓCo_{y}Al_{z}DδO₂ (XNCA), respectively, to explicitly list small amount, 6, of one or more dopants, D. For brevity and clarity, the possibility of inclusion of one or more dopants is taken as implicit herein and the shorter form of the formulae generally used. It will be appreciated that an NMC material doped with Al, or an NCA material doped with Mn, may be referred to as an NMCA material.

The method may allow leaching to occur within minutes, for example within 5 minutes for an unused/pristine electrode material, and within 10 or 20 minutes for a used/end-of-life cathode material.

Due to the relatively gentle and selective nature of the leaching treatment, if the leaching is performed on an unused cell, the remaining, unleached, electrode material may be directly recovered and recoated on to a fresh current collector for re-use. This approach may allow other electrode components, such as a PVDF binder and/or active carbon, to be recycled as well as the unleached active electrode material(s).

The method may allow leaching to occur at relatively low temperatures as compared to current techniques, for example at a temperature below 150° C., optionally below 100° C., optionally between 15° C. and 90° C. or between 40° C. and 90° C., and further optionally around 70° C. In some embodiments, leaching may be performed at room temperature—a relatively long leaching time, for example of one hour, may be used for lower-temperature leaching, e.g. in the range from 15° C. to 60° C. or 15° C. to 50° C., optionally from 15° C. to 40° C., and further optionally around 20° C.

The selectivity of the leaching of the mixed-phase material may prevent all phases from being drawn into solution—in particular, relatively high Ni-content phases may be retained in the electrode material (which is often provided as a strip), whilst relatively high Mn-content phases (≥20% Mn as a mole percentage of transition metal content) may be removed. This may facilitate separation of streams for regeneration of one or both through direct routes.

This automatic separation may allow for the mixing of electrode materials (e.g. cathode strips) with different cell chemistries—the process can be used to treat not only blended materials (e.g. a cathode containing multiple different phases) but also mixed black mass from a battery shredding process (e.g. materials from multiple chemically-distinct cathodes, the overall mixed black mass containing multiple different phases whether or not individual cathodes did).

The mixed-phase battery electrode material may be a cathode material from a sodium ion battery (Na-ion), a lithium ion battery (Li-ion), or a mixed Na/Li-ion battery.

The acid may be an organic acid or a combination of multiple organic acids. As the term is used herein, an organic acid is any carbon-containing acid.

Optionally, the acid may comprise one or more of ascorbic acid, oxalic acid, citric acid, and formic acid. The acid may be ascorbic acid only in some embodiments. Use of an acid such as ascorbic acid or citric acid may provide one or more of the following benefits:
Ease of storage of acid—e.g. ascorbic acid can be stored as a solid and made up into the correct concentration if/when needed.
Relatively low cost.
Avoidance of the use of highly concentrated corrosive inorganic acids currently widely used in battery material recycling (e.g. H₂SO₄).
The acid may perform the roles of both the leaching acid and reducing agent, so avoiding the use of currently widely-used reducing agents such as hydrogen peroxide (H₂O₂). The peroxide requires refrigerated storage, therefore, when an acid such as ascorbic acid is utilised, energy/storage costs are also reduced.

The acid may have a pKa in the range from 2 to 12, and optionally from 2.5 to 11.5 or from 2.9 to 11.0. In some embodiments, the pKa may be greater than or equal to 2, 2.5, or 2.9, and may optionally be around 3.

The acid solution may have a pH of zero.

The acid may be ascorbic acid, and the acid solution may be an ascorbic acid solution with a molarity in the range from 0.25M to 1.5M, and optionally equal to or around 1.25 M.

A solid to liquid ratio of the electrode material to the acid solution may be 1 g of electrode material per 20 ml of acid solution.

The treating of the electrode material may be arranged to leach out at least substantially only manganese-containing phases from the electrode material. Optionally the treatment may be arranged to leach out at least substantially only phases in which manganese makes up at least 20%, and optionally at least 50%, of the transition metal content (mole ratio). Examples of such phases include LiMn₂O₄(LMO) and NaMn₂O₄(NaMO).

The electrode material may be or comprise a blended cathode strip of LMO (or NaMO) and a layered oxide. The treating of the electrode material may be arranged to selectively leach out the LMO (or NaMO) whilst leaving the layered oxide at least substantially intact.

The treating of the electrode material may comprise exposing the electrode material to the acid for a period of no more than one hour, and optionally of less than 30 minutes, 20 minutes, ten minutes, or five minutes.

The treating of the electrode material may comprise exposing the electrode material to the acid for a longer time period when treating electrode material from an end-of-life (used) battery than when treating electrode material from a quality-control rejected new battery, optionally by a factor of two.

The treating of the electrode material may be performed at a temperature of between 15° C. or 20° C. and 90° C., optionally between 40° C. and 90° C., and further optionally at around 70° C.

The electrode material may comprise one or more unshredded cathode strips—shredding prior to treatment is therefore not necessary, although the treatment can also be used for shredded cathode strips. The acid solution remaining after the leaching treatment—the leachate—may be used in regeneration. Beneficially, there may therefore be no costs associated with disposal of the leaching acid as this becomes the feedstock for a recycling process rather than a waste product.

In embodiments in which the electrode material is or comprises a blended cathode strip of LMO and a layered oxide, and wherein the treating of the electrode material is arranged to selectively leach out the LMO whilst leaving the layered oxide at least substantially intact, the method may further comprise re-generating an LMO phase from the leachate. The re-generating may comprise: drying the leachate so as to form a precipitate (i.e. evaporation of the solvent to yield a precipitate) and/or the addition of reagents to trigger the precipitation of a mixed metal hydroxide from the leached solution; grinding the precipitate (formed by simple drying and/or reagent addition); and annealing the ground precipitate in air (or another appropriate oxygen-containing atmosphere).

Additionally or alternatively, in embodiments in which the electrode material comprises LMO or NaMO which is then leached by the acid solution, the method may further comprise generating a target XNiₓMn_{y}Co_{z}O₂(XNMC) phase from the leachate, where X is Li, Na, or a combination of the two. The generating of the target phase may comprise a sol-gel approach including:
gravimetrically determining the amount of leached LMO or NaMO in the leachate, and, based on the gravimetrically determined amount of leached LMO or NaMO:
   calculating a molar amount of a cobalt—and nickel-containing sulfate, M(SO₄)—nH₂O (where M=Co and Ni), required to obtain the target XNMC composition from the leachate; and
   calculating a molar amount of a carbonate or hydroxide of X required to obtain the target XNMC composition from the leachate;
combining the calculated amount of M(SO₄)—nH₂O with the leachate;
adding a molar amount of a soluble source of a cation selected to trigger the precipitation of a sulfate, so as to remove the sulfate from the leachate solution, the molar amount to add being calculated from the molar amount of M(SO₄)—nH₂O and the Co:Ni ratio of M to the leachate solution (for example, adding a molar amount of a soluble source of barium (or calcium or strontium, or another suitable cation for forming a relatively insoluble sulfate) calculated from the molar amount of M(SO₄)—nH₂O and the Co:Ni ratio of M to the leachate solution to trigger the precipitation of BaSO₄ (or calcium sulfate, strontium sulfate etc.) so as to remove the sulfate from the leachate solution);
drying the leachate solution so as to form a precipitate;
grinding the precipitate with the calculated amount of a carbonate or hydroxide of X; and
annealing the ground material in air (or oxygen, or another suitable oxygen-containing atmosphere).

Alternatively, the generating of the target phase may comprise:
gravimetrically determining the amount of leached LMO or NaMO in the leachate, and, based on the gravimetrically determined amount of leached LMO or NaMO:
   calculating a molar amount of a soluble source of cobalt and nickel (e.g. one or more of nitrates, acetates, and sulfates) required to obtain the target XNMC composition from the leachate; and
   calculating a molar amount of a carbonate or hydroxide of X required to obtain the target XNMC composition from the leachate;
combining the calculated amount of the soluble source of cobalt and nickel with the leachate; adding an OH⁻ source (e.g. a hydroxide such as NH₄OH, KOH, NaOH or LiOH) until a precipitate is formed (the precipitate being a target NMC(OH)₂ phase);
drying the precipitate;
grinding the precipitate with the calculated amount of the carbonate or hydroxide of X; and annealing the ground material in air/oxygen (or another suitable oxygen-containing atmosphere).

The generating may further comprise calculating the required molar amount of NaOH/NH₄(OH)/LiOH (or other suitable hydroxide) to be added to the solution to trigger the precipitation of the target NMC(OH)₂ phase—it will be appreciated that precipitation of this target phase generally occurs once the pH of this solution reaches 11. Suitable hydroxides for use as a hydroxide (OH—) source in this method include (NH₄)OH, LiOH,NaOH, KOH and hydrated equivalents
this list is provided by way of example only, and is not intended to be limiting. Low cost and/or environmental effects of the use of the hydroxide may be considered in the selection.

The method may further comprise:
gravimetrically determining an amount of material lost from the mixed-phase battery electrode material into the leachate; and
adding a stoichiometric amount of one or more reagents to the leachate to introduce desired metal cations, so as to generate a desired battery cathode material.

The leachate may therefore be recycled to either re-form the leached material, or to form a different battery electrode material.

The amount of leached material to be recycled (e.g. spinel) in the leachate solution may be determined gravimetrically by weighing the (dried) cathode strip before and after application of the selective leaching process—gravimetric determination may allow for quick regeneration/recycling of Li and/or Mn in the solution, with no need for careful elemental analyses.

The leachate containing the leached phase (e.g. spinel), can be used to either regenerate the leached phase or to make different materials. If the same phase is to be regenerated, no further addition of metals is generally needed, although some Li and/or Na may be required to account for loss due to degradation reactions in some cases—any amount of Na and/or Li required to make up for degradation losses may be determined from a battery's capacity prior to disassembly. If a different phase is to be generated, addition of appropriate elements in appropriate amounts is likely to be needed.

Suitable materials which may be formed from the leachate may include Mn-containing O-redox cathode materials, Ni-doped spinels, and various NMC compositions (e.g. NMC532). Cathode materials from previous-generation cathodes may therefore be “upcycled” to provide current-generation cathode materials by adjusting the metal ions added to the leachate during the recycling process. Materials particularly suited to the processes described herein may contain at least 20% Mn, as a percentage of their transition metal content—a material with only a trace amount of Mn, e.g. as an impurity, is unlikely to provide the same level of leaching. The processes described herein may be especially effective for Mn-rich electrode materials. As used herein, “Mn-rich” electrode materials may refer to any electrode material that contains≥50% Mn as a percentage of its transition metal content, therefore including cathode materials such as LiMnO₂ and Li₂MnO₃.

According to a second aspect of the invention, there is provided a battery material regeneration method for resynthesizing XNiₓMn_{y}Co_{z}O₂(XNMC) or XNiₓCo_{y}Al_{z}O₂(XNCA), where X is Na, Li, or a mixture of the two, the method comprising:
obtaining an XNMC- or XNCA-containing electrode material from a battery cathode;
combining the material with sodium hydroxide and heating the mixture to form a precipitate of NMC(OH)₂ or NCA(OH)₂, as appropriate, with X going into solution;
extracting and drying the NMC(OH)₂ or NCA(OH)₂ precipitate;
grinding the precipitate with a gravimetrically-determined stoichiometric amount of a carbonate or hydroxide of X; and
heating the resultant powder to resynthesise XNMC or XNCA.

In some cases, in particular when the material is a material with a higher Ni content (≥60%), the precipitate is substantially pure mixed metal hydroxides (NMC(OH)₂ or NCA(OH)₂). In other cases, in particular when the material is a material with a lower Ni content (60%), the precipitate is a mixture of hydroxide and layered oxide phases of the same material—i.e. of NMC(OH)₂ or NCA(OH)₂ and the corresponding oxide. The “precipitate of NMC(OH)₂ or NCA(OH)₂” described in methods of this aspect may therefore be a precipitate of only the named hydroxide, or of that hydroxide mixed with a corresponding layered oxide.

Lithium hydroxide may be used in place of sodium hydroxide in some embodiments, for the step of combining the material with the hydroxide and heating the mixture to form a precipitate of NMC(OH)₂ or NCA(OH)₂ (and optionally also the corresponding oxide), as appropriate, with X going into solution.

Where XNMC is the phase present in the electrode material, and therefore the phase to be regenerated, the battery material regeneration method for resynthesizing XNiₓMn_{y}Co_{z}O₂(XNMC), where X is Na, Li, or a mixture of the two, comprises:
obtaining XNMC-containing material from a battery cathode;
combining the material with sodium hydroxide (or with another suitable OH⁻ source such as NH₄OH, KOH, NaOH or LiOH, e.g. by adding sodium hydroxide solution to the material) and heating the mixture to form NMC(OH)₂, with X going into solution;
extracting and drying the NMC(OH)₂ precipitate;
grinding the NMC(OH)₂ precipitate with a gravimetrically-determined stoichiometric amount of a carbonate or hydroxide of X; and

heating the resultant powder to resynthesise XNMC.

Where XNCA is the phase present in the electrode material, and therefore the phase to be regenerated, the battery material regeneration method for resynthesizing XNiₓCo_{y}Al_{z}O₂(XNCA), where X is Na, Li, or a mixture of the two, comprises:
obtaining XNCA-containing material from a battery cathode;
combining the material with sodium hydroxide and heating the mixture to form NCA(OH)₂, with X going into solution;
extracting and drying the NCA(OH)₂ precipitate;
grinding the NCA(OH)₂ precipitate with a gravimetrically-determined stoichiometric amount of a carbonate or hydroxide of X; and heating the resultant powder to resynthesize XNCA.

If an electrode material had degraded or developed a fault prior to recycling, or if its use life-time is unknown, this hydrothermal hydroxide method may be used to reliably regenerate certain electrode materials (e.g. materials such as NMC remaining in a cathode strip leached according to the method of the first aspect). This hydrothermal hydroxide process may offer one or more of the following advantages:
It may ‘heal’ layered materials that have undergone degradation reactions (e.g. due to Ni migration into a Li layer).
It may allow the use of relatively inexpensive NaOH in place of LiOH.
It may allow the use of stoichiometric quantities of NaOH or LiOH (or a corresponding carbonate used as a metal ion source), so avoiding the use of excessive reagents, reducing cost.
   In particular, the LiOH/Li₂CO₃ amount or NaOH/Na₂CO₃ amount can be accurately calculated gravimetrically during the annealing regeneration step, based on the measured mass of NMC(OH)₂—this prevents large unnecessary excesses of reagents being used as in prior techniques.
It may allow the use of a relatively low temperature treatment—for example less than 250° C., less than 200° C., or optionally less than or equal to 160° C.
It may break down a binder present in the electrode material, such as PVDF binder, so avoiding fluorine impurities or the like in the regenerated electrode materials.
It may produce Na₂CO₃ as a by-product—this is a common agent used to precipitate Li₂CO₃ from solution so may be used to retrieve dissolved lithium.
It may allow for the recovery of Li from the solution, to be reused in regeneration or otherwise recycled.

In cases where the selected OH⁻ source is NaOH, the sodium hydroxide may be provided as an aqueous NaOH solution, optionally with a molarity in the range from 0.5 M to 1 M.

The heating the mixture to form NMC(OH)₂ (either alone or part of a mixed oxide/hydroxide phase, as discussed above) may be performed for a time period of at least two hours. The heating the mixture to form NMC(OH)₂ may be performed at a temperature of over 100° C. and optionally of around 160° C.

The material obtained from the battery cathode may comprise a binder. The combining the material with sodium hydroxide (or other OH⁻ source) may be arranged to remove the binder from the NMC material, optionally by forming Na₂CO₃ and NaF.

The heating step may comprise heating the mixture of NMC(OH)₂ (or NCA(OH)₂, as appropriate, optionally also with the corresponding oxide as discussed above) and LiOH—H₂O to 850° C.

The method may further comprise: grinding the NMC; and annealing the NMC in air, optionally at a temperature of around 700° C. for a period of around 12 hours.

According to a third aspect, there is provided a lithium-ion and/or sodium-ion battery recycling method comprising:

obtaining a battery electrode material, the electrode material comprising multiple phases at least one of which is manganese-containing;

treating the battery electrode material with a solution of an acid with pKa greater than or equal to −2, the acid acting as both a leaching agent and a reducing agent, so as to form a manganese-containing leachate whilst leaving at least one phase of the battery electrode material unleached, wherein the battery electrode material is exposed to the acid solution for a period of less than twenty minutes;

draining off the leachate; and

regenerating at least one unleached phase.

The obtaining may comprise obtaining a manganese-containing mixed-phase battery electrode material from a single cell or cell type with a mixed-phase (blended) electrode. Alternatively or additionally, the obtaining may comprise obtaining a mixture of battery electrode materials from different cells or cell types, with the mixture containing multiple phases, and optionally containing one or more blended electrodes. The at least one Mn-containing phase may be at least 20% Mn, as a percentage of its transition metal content.

The battery electrode material may be exposed to the acid solution for a period of not more than twenty minutes, and optionally not more than ten minutes.

The method may further comprise resynthesizing a manganese-containing battery material from the leachate, the battery material formed optionally being the same phase as initially dissolved into the leachate. In embodiments in which the leached phase is LMO, the resynthesizing the manganese-containing battery material from the leachate may comprise resynthesizing LMO by the LMO-regeneration method as described with respect to the first aspect. In embodiments in which the leached phase is LMO, the leachate may be used to generate an NMC phase by the NMC-synthesis method as described with respect to the first aspect.

In embodiments in which the unleached phase is a layered oxide, the regenerating the unleached phase may comprise: forming a hydroxide of the unleached phase; grinding the hydroxide of the unleached phase with a stoichiometric amount of LiOH—H₂O for a Li-ion battery material, or NaOH—H₂O for a Na-ion battery material (or a mixture of the two for a mixed Li— and Na-ion battery); and heating the resultant powder to resynthesize the original phase. As discussed above for the second aspect, in some implementations (especially when using a starting material with a Ni content of less than 60%) a the hydroxide formed may be mixed with a corresponding layered oxide—the mixture of oxide/hydroxide phases is treated in the same way.

In embodiments in which the unleached phase is XNMC, the regenerating the unleached phase may comprise regenerating the XNMC by the method described for the second aspect.

Various aspects and embodiments of the invention may therefore provide an efficient process that selectively leaches relatively low value spinel electrode material (e.g. LiMn₂O₄(LMO)) in minutes from blended cathode strip (e.g. LMO/LO), allowing both to be effectively recovered separately. This process may not only avoid lengthy dissolution of all cathode components, but may also allow for the direct regeneration of the spinel phase (with no further metal addition) or the upcycling of the Li/Mn from the resultant leachate solution into higher value NMC phases.

The remaining layered oxide in the cathode strip (often Ni-rich), left behind following leaching, may be directly regenerated through a hydrothermal-hydroxide process. The hydrothermal hydroxide process of various embodiments also decomposes the PVDF binder, therefore potentially avoiding fluorine contamination in the recovered layered oxide.

In embodiments implementing a combined process of leaching and regeneration, the embodiments may utilise the different stabilities of transition metals in acidic media to allow for direct recycling of the layered oxide phase. Such embodiments may offer the ability to recover and regenerate both components (i.e. synthesis of useful products from both the leachate and the remaining unleached material), and may be future-proof with regards to novel materials (e.g. future target cathode materials), in that the selection and ratios of metal ions added in the resynthesis steps may be adjusted as applicable to generate a desired material.

Embodiments described herein may therefore provide examples of a process to efficiently recycle blended cathodes containing LMO spinel and LO phases, such as cathodes of Lithium-ion and Sodium-ion batteries.

In particular, embodiments described herein may provide a selective leaching process (optionally using ascorbic acid as both the leaching acid and the reducing agent) that can efficiently remove LiₐNa₁₋ₐMn₂O₄, or another manganese-rich Li— or Na—containing phase, from blended electrodes, leaving behind one or more other phases, such as a Ni—rich NMC or NCA phase, to be regenerated separately. By way of example, the process described herein may be used to selectively leach low value spinel electrode material (e.g. LiMn₂O₄(LMO)) from a blended cathode strip (LMO/LO) in minutes, allowing both phases to be effectively recovered separately.

The process described herein may offer improved efficiency, for example by not only avoiding lengthy dissolution of all cathode components, but also allowing for the direct regeneration of the spinel phase (with no further metal addition) or the upcycling of the Li (and/or Na)/Mn from the resultant leachate solution into higher value NMC or NCA phases.

In various embodiments, the remaining one or more phases in the remaining, unleached electrode material (e.g. a remaining Ni—rich layered oxide in the cathode strip) can be directly regenerated through a hydrothermal-hydroxide process. Such a hydrothermal hydroxide process may also decompose the PVDF binder commonly used in such cathode strips, therefore avoiding fluorine contamination in the recovered layered oxide.

Embodiments incorporating this combined process may utilise the different stabilities of transition metals in acidic media to allow for direct recycling of the layered oxide phase. A process for efficiently recycling blended cathodes, for example containing LMO spinel and LO phases, is therefore disclosed.

The skilled person would understand that features described with respect to one aspect of the invention may be applied, mutatis mutandis, to any other aspect of the invention.

There now follows, by way of example only, a detailed description of embodiments of the present invention with reference to the accompanying drawings in which:

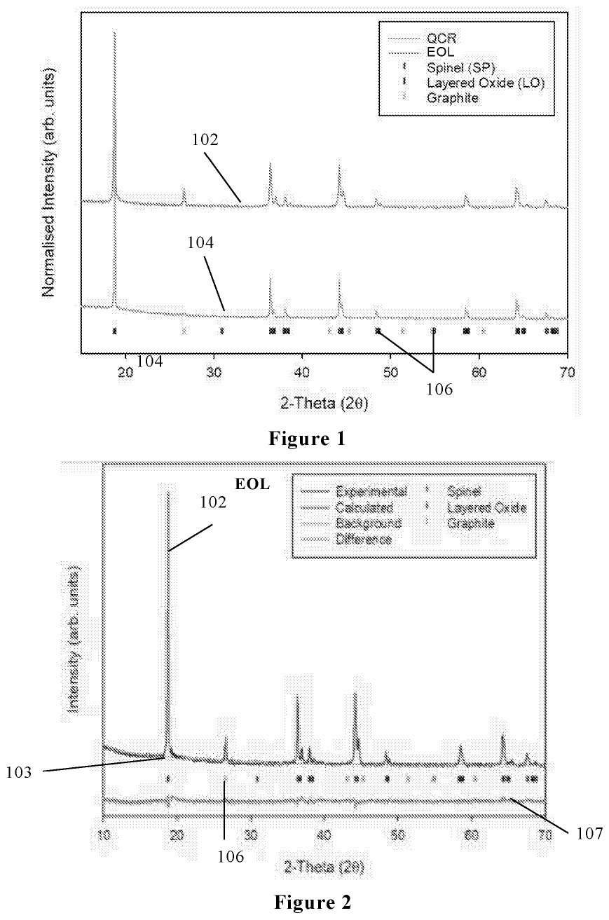

FIG. 1 shows Powder X-Ray Diffraction (PXRD) plots for two different cathode strips prior to leaching;

FIG. 2 shows PXRD and difference plots for a used (end-of-life—EOL) cathode strip from an LMO/Ni—rich layered oxide cell;

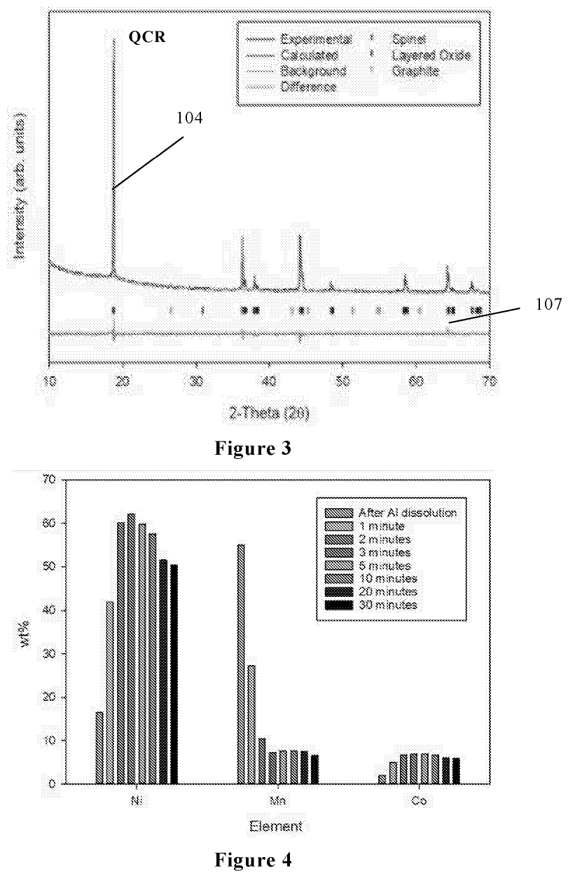

FIG. 3 shows PXRD and difference plots for a quality-control (QC) rejected (unused, except for quality testing) cathode strip from an LMO/Ni—rich layered oxide cell;

FIG. 4 shows X-Ray Fluorescence (XRF) data for QC-rejected (QCR) cathode strip samples undergoing leaching with ascorbic acid;

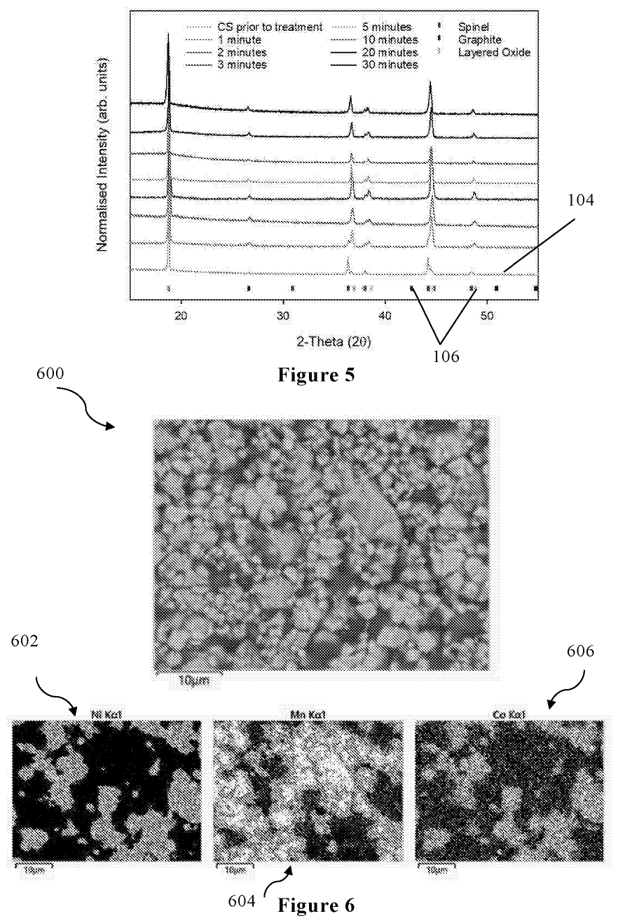

FIG. 5 shows PXRD data for the same QCR cathode strip samples undergoing leaching with ascorbic acid;

FIG. 6 shows Scanning Electron Microscopy (SEM) images and Energy Dispersive X-Ray Analysis (EDX) data for a QCR strip sample before leaching (5-minute treatment time);

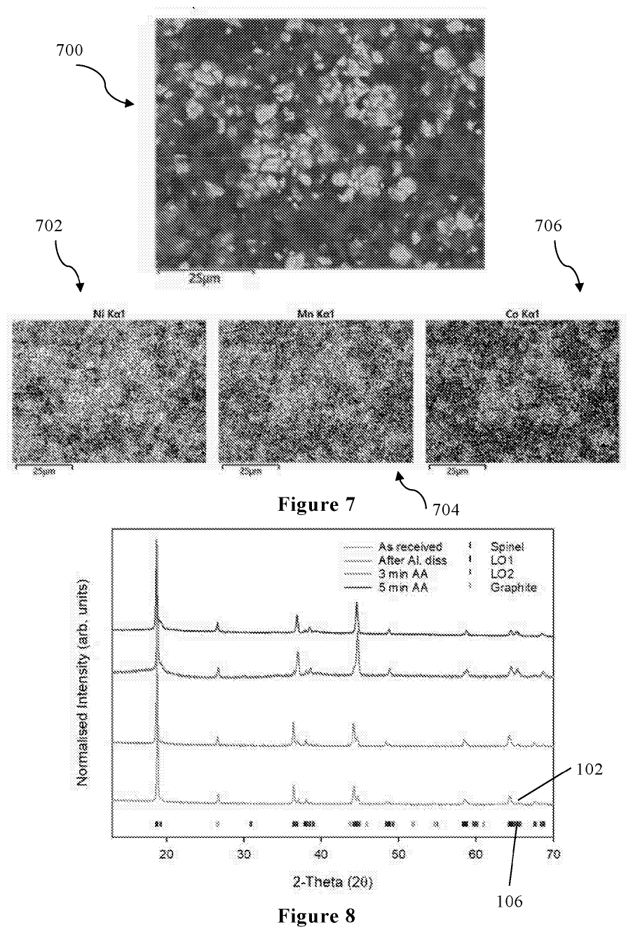

FIG. 7 shows SEM images and EDX data of a QCR strip sample after leaching (5-minute treatment time);

FIG. 8 shows PXRD data for used samples after leaching with ascorbic acid;

FIG. 9 shows a comparison of XRF data for QCR and used (EOL) samples undergoing the same ascorbic acid leaching treatment;

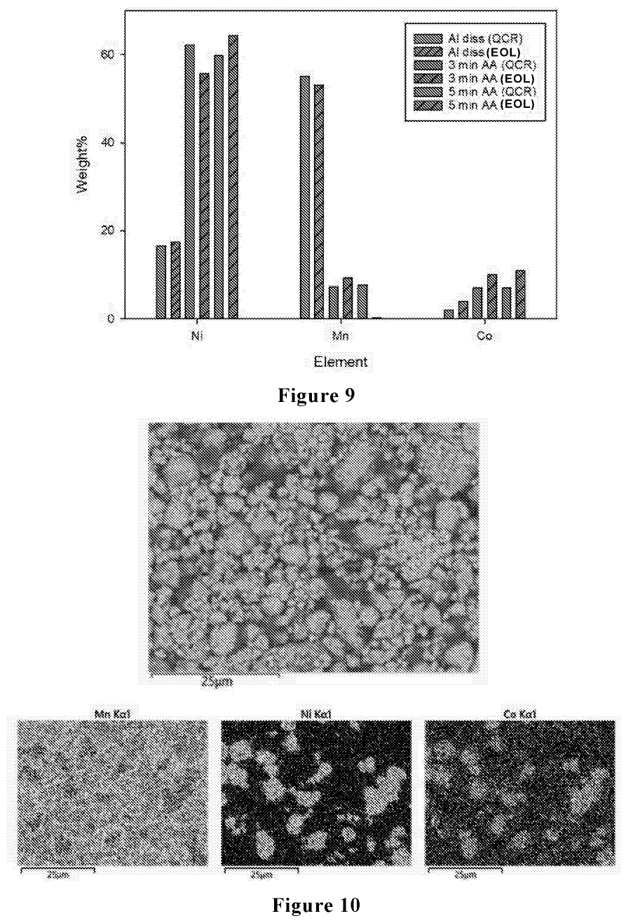

FIG. 10 shows SEM images and EDX data of an EOL strip before leaching (5-minute treatment time);

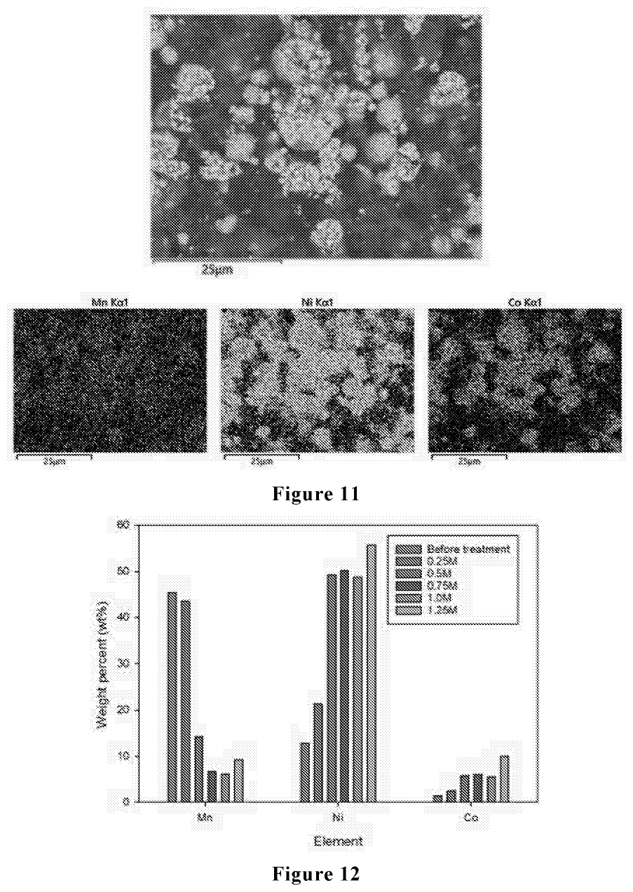

FIG. 11 shows SEM images and EDX data of an EOL strip after leaching (5-minute treatment time);

FIG. 12 shows XRF data for QCR samples treated with various leaching solution concentrations;

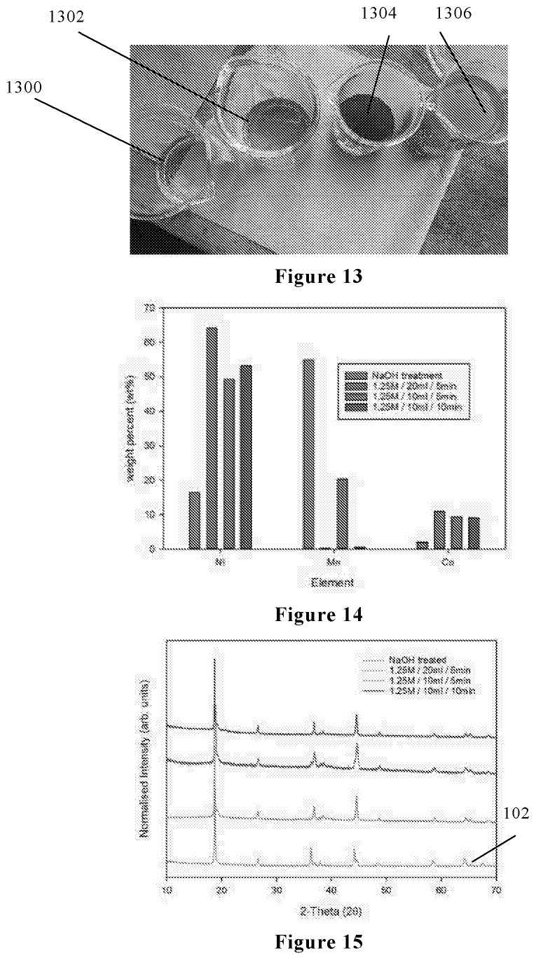

FIG. 13 shows photographs of solutions illustrating variations in precipitation with concentration of the leaching solution;

FIG. 14 shows XRF data for EOL cathode strips treated with varying volumes of a sodium hydroxide solution for varying periods;

FIG. 15 shows corresponding PXRD data for the EOL cathode strips treated with varying volumes of a sodium hydroxide solution for varying periods;

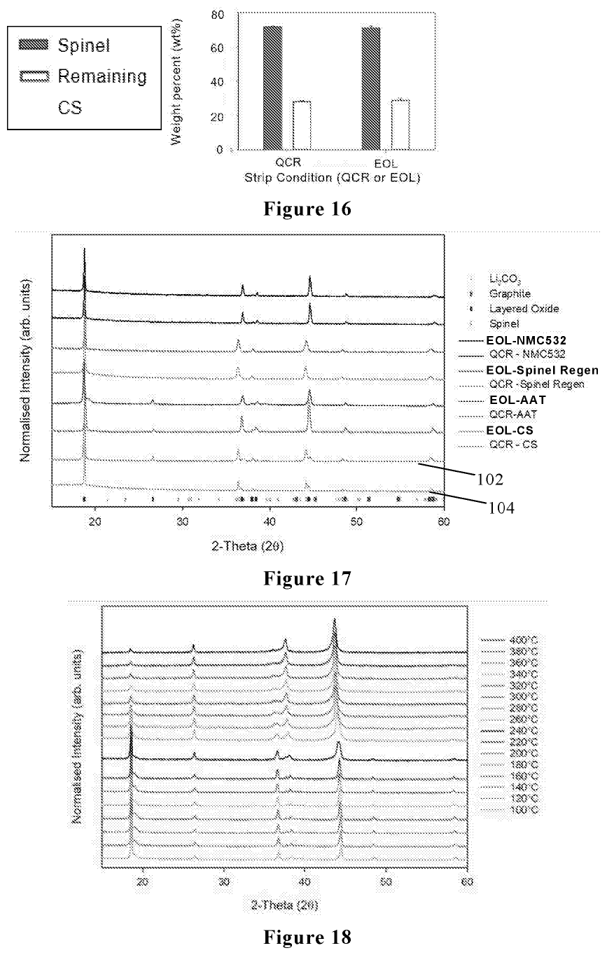

FIG. 16 shows gravimetrically determined weight percentages of spinel remaining in cathode strip samples after leaching;

FIG. 17 shows PXRD data for regenerated spinel and upcycled NMC532 made from QCR and EOL leached solutions;

FIG. 18 shows variable-temperature-PXRD for an EOL cathode strip sample heated to 400° C.;

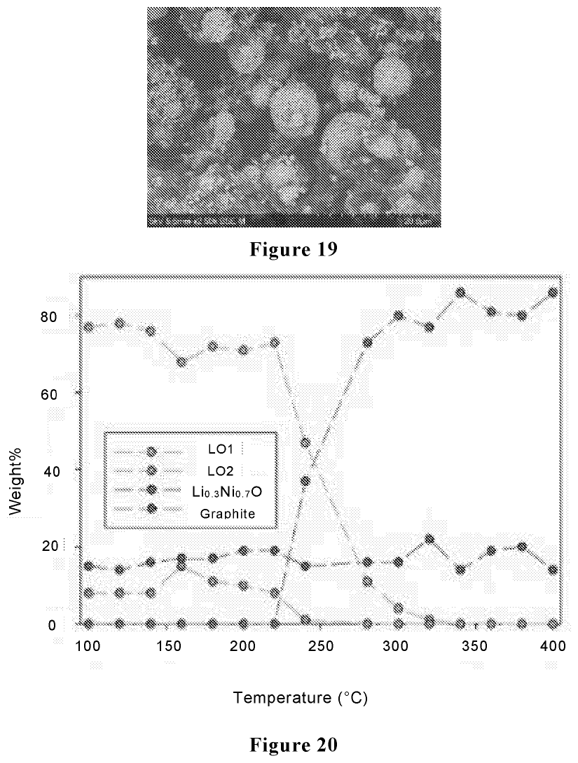

FIG. 19 shows an SEM image of a portion of the EOL cathode strip for which the VT-PXRD data are shown in FIG. 18, after the heat treatment;

FIG. 20 illustrates a phase change occurring during the heat treatment;

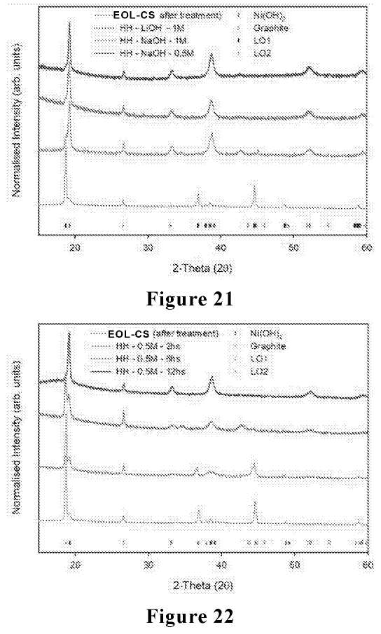

FIG. 21 shows PXRD data for an EOL cathode strip that has undergone hydrothermal hydroxide (HH) treatment with LiOH and NaOH;

FIG. 22 shows PXRD data for a timed study illustrating the loss of the Ni—rich layered oxide phases and appearance of the hydroxide with longer treatment times;

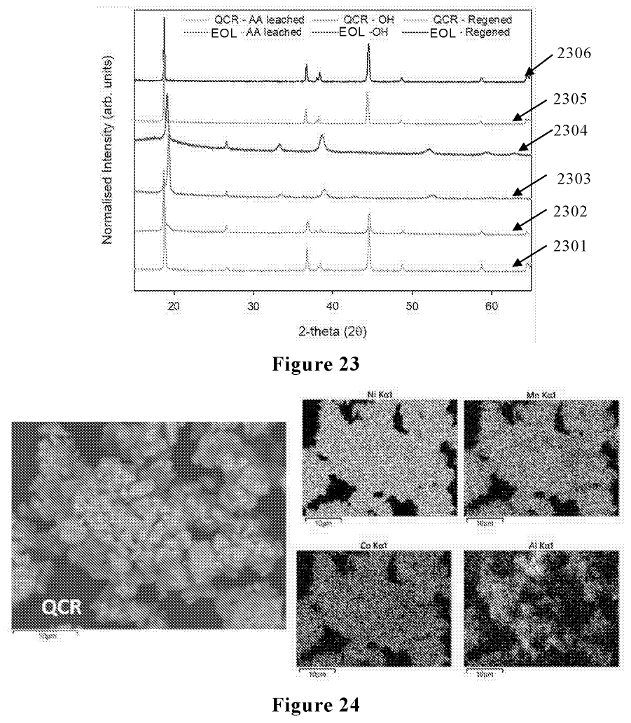

FIG. 23 shows PXRD data for QCR and EOL cathode strips after leaching, the hydroxides produced from the HH-treatment and the resulting NMC phases generated after 850° C./12 hs heat treatment;

FIG. 24 shows SEM-EDX mapping data for a QCR sample regenerated through the HH treatment;

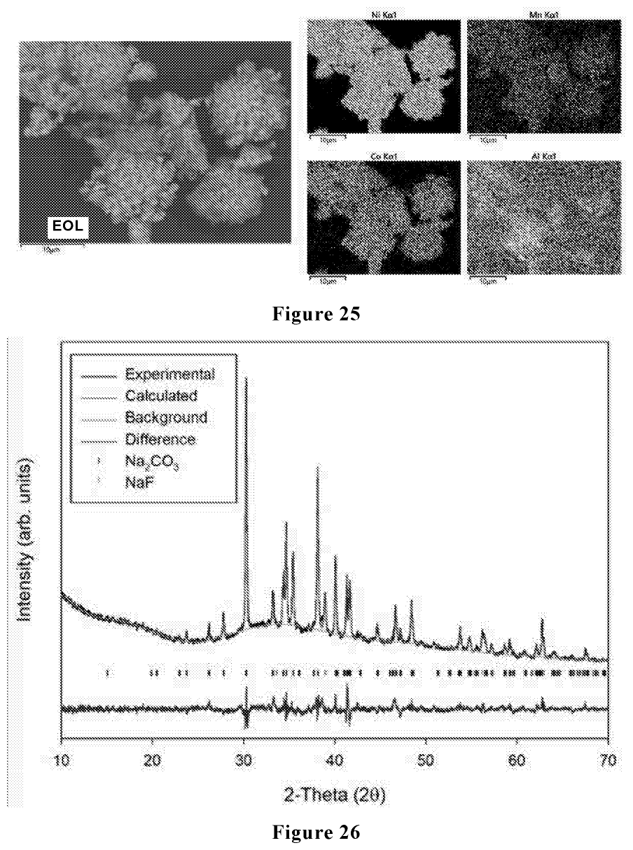

FIG. 25 shows SEM-EDX mapping data for an EOL sample regenerated through the HH treatment;

FIG. 26 shows PXRD data for the precipitate obtained after evaporating the hydrothermal filtrate;

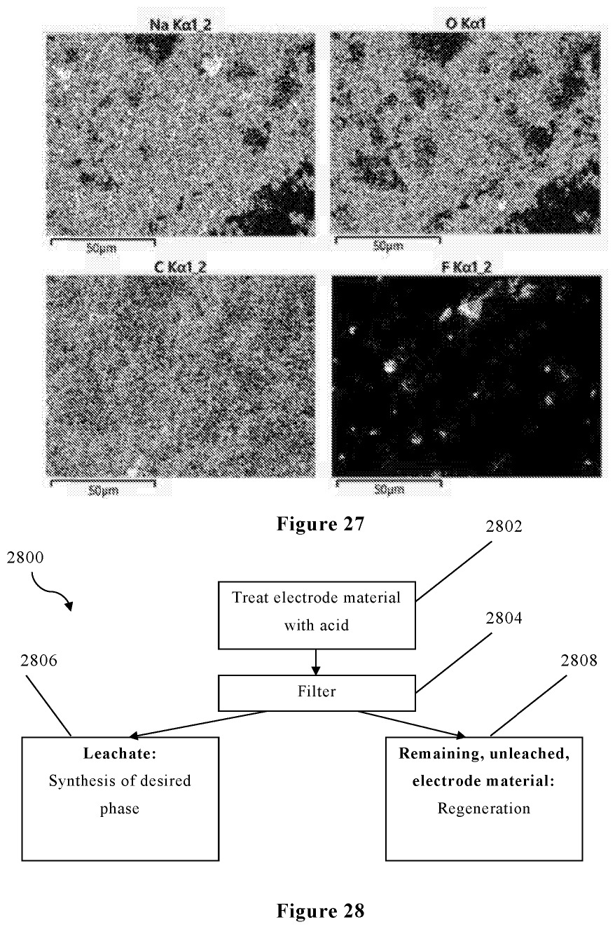

FIG. 27 shows EDX data for the precipitate obtained after evaporating the hydrothermal filtrate;

FIG. 28 illustrates a method of various embodiments;

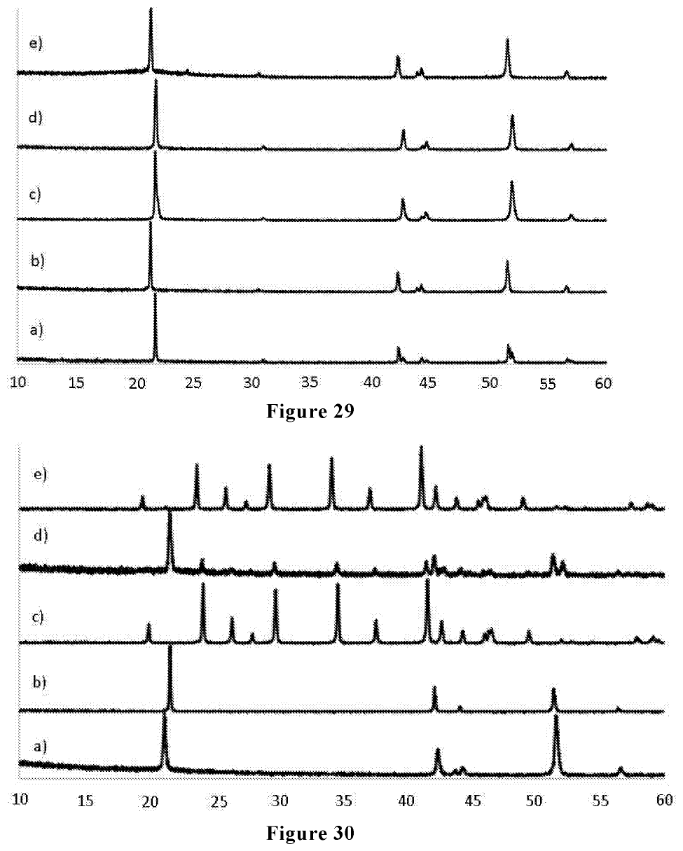

FIG. 29 shows X-ray diffraction patters for a QCR cathode strip before and after various treatments with ascorbic acid;

FIG. 30 shows X-ray diffraction patters for simulated mixed cathode materials after various treatments with ascorbic acid;

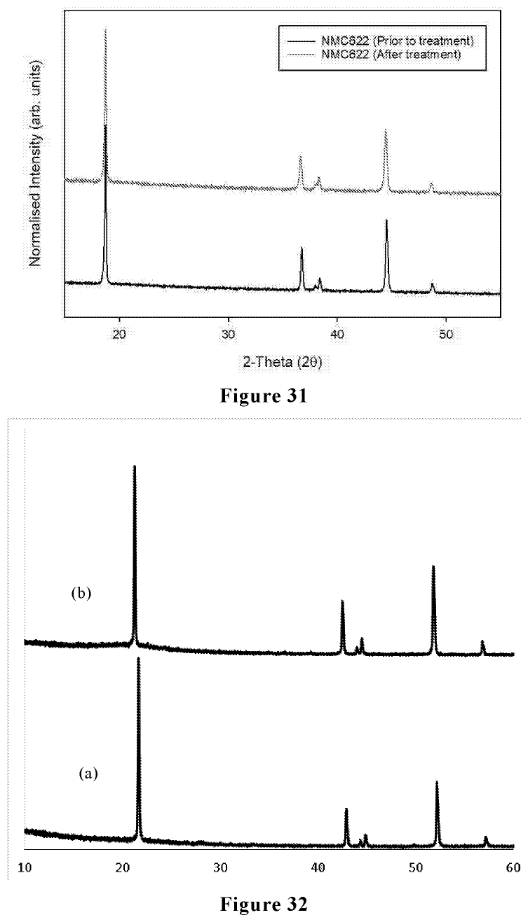

FIG. 31 shows PXRD data for NMC622 before and after treatment with ascorbic acid;

FIG. 32 shows PXRD data for NMC532 synthesised from the precipitation of NMC532(OH)₂ from a solution containing leached spinel from (a) a QCR cathode strip and (b) an EOL cathode strip;

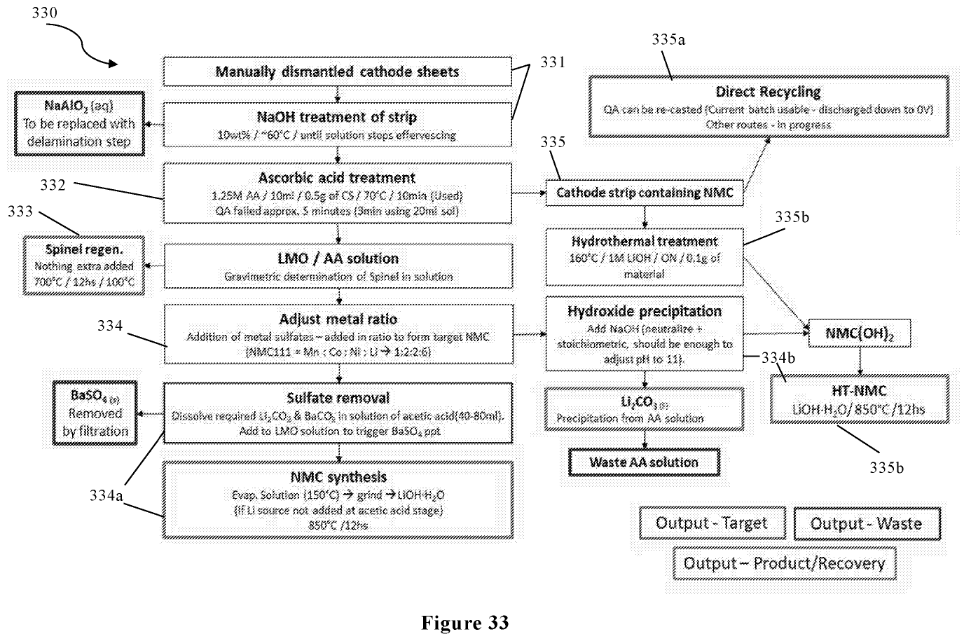

FIG. 33 shows an example recycling process summary for an LMO/NMC blended cathode strip;

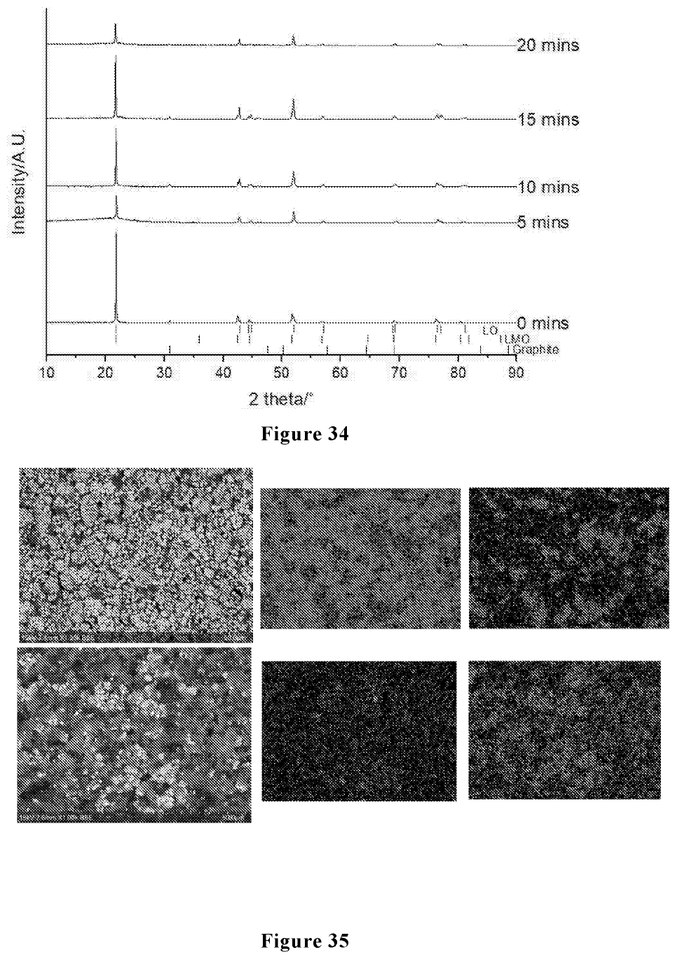

FIG. 34 shows XRD patterns of 30 g/L QCR cathode after leaching in 10 mL of 1 M citric acid for 0, 5, 10, 15 and 20 minutes; tick marks correspond to LO, LMO and graphite;

FIG. 35 shows SEM (left) and EDX (right) images of the QCR cathode before (top) and after (bottom) leaching for 20 minutes with an ascorbic acid solution; the EDX images correspond to Mn (middle) and Ni (right);

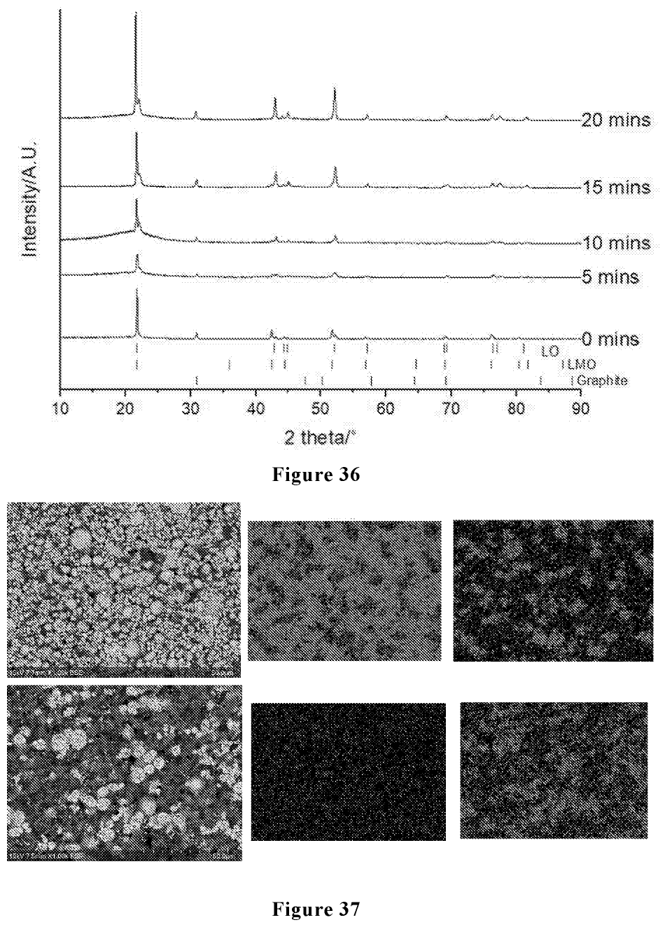

FIG. 36 shows XRD patterns of 30 g/L EOL cathode after leaching in 10 mL of 1 M citric acid for 0, 5, 10, 15 and 20 minutes; tick marks correspond to LO, LMO and graphite;

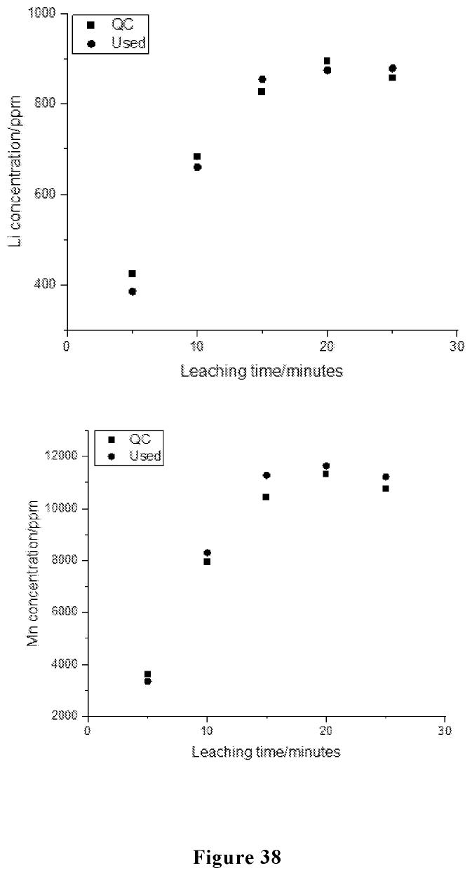

FIG. 37 shows SEM (left) and EDX (right) images of the EOL cathode before (top) and after (bottom) leaching for 20 minutes; the EDX images correspond to Mn (middle) and Ni (right);

FIG. 38 shows ICP-OES data showing the Li (top) and Mn (bottom) concentration in the 1 M citric acid leaching solution containing 30 g/L QCR (squares) and EOL (circles) cathode material at different leaching times;

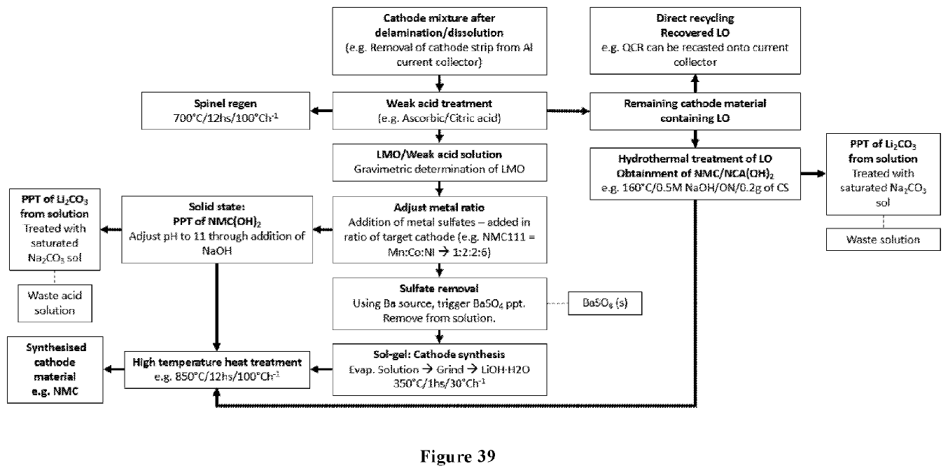

FIG. 39 shows an example recycling process summary similar to that shown in FIG. 33;

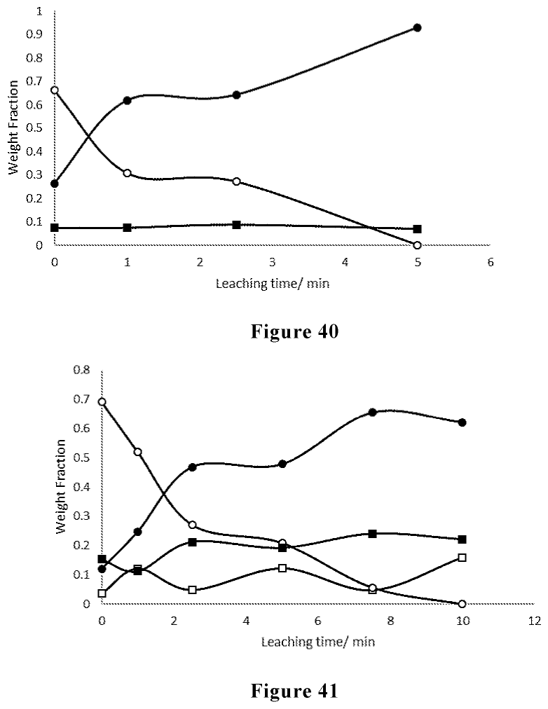

FIG. 40 illustrates Rietveld refinements results, showing weight fraction of quality control rejected (QCR) cathode strip during ascorbic acid leaching; phases are given as an open circle (spinel), filled circle (layered oxide) and filled square (carbon);

FIG. 41 illustrates Rietveld refinements results, showing weight fraction of EOL cathode strip during ascorbic acid leaching; phases are given as an open circle (spinel), filled circle (layered oxide), filled square (second layered oxide) and open square (carbon);

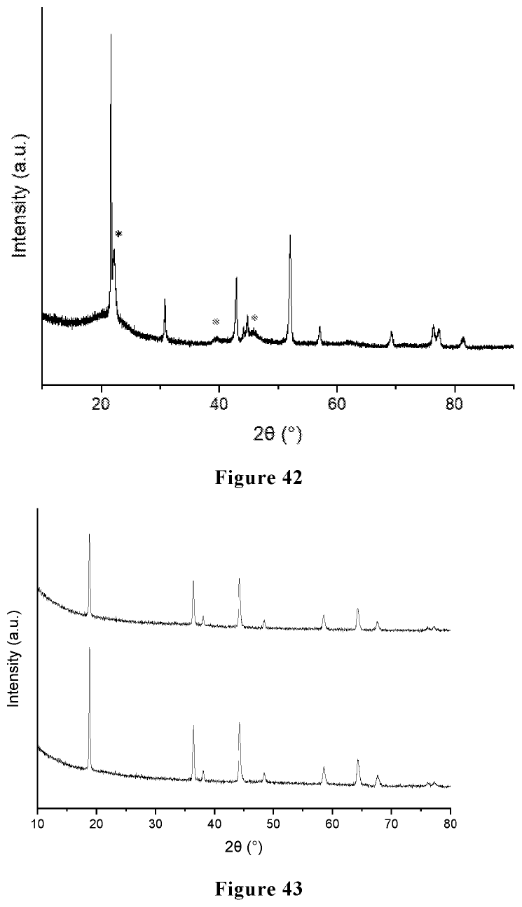

FIG. 42 shows X-ray diffraction data of EOL cathode strip after ascorbic acid treatment; asterisks indicate additional layered oxide phase (black) and rock salt phase (grey);

FIG. 43 shows X-ray diffraction patterns for LiMn₂O₄ synthesised from a) QCR and b) EOL ascorbic acid leachates;

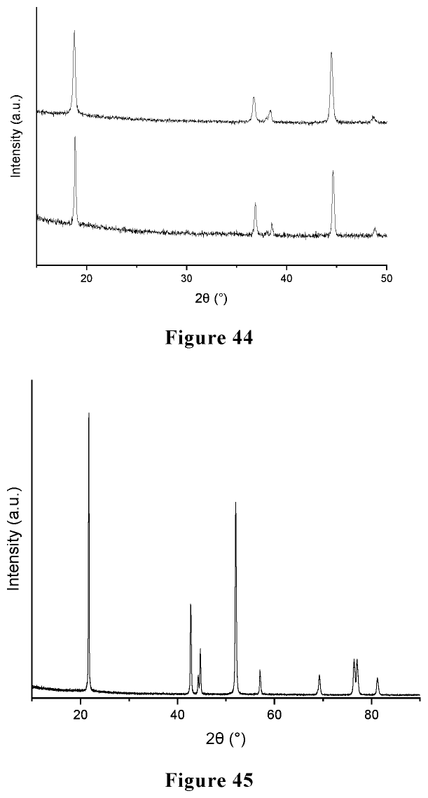

FIG. 44 shows X-ray diffraction patterns for NMC 532 synthesised using the ascorbic acid leachate (EOL) using a) hydroxide route and b) sulfate exchange route;

FIG. 45 shows the X-ray diffraction pattern for a layered oxide phase regenerated from an EOL-CS via the hydrothermal route; and

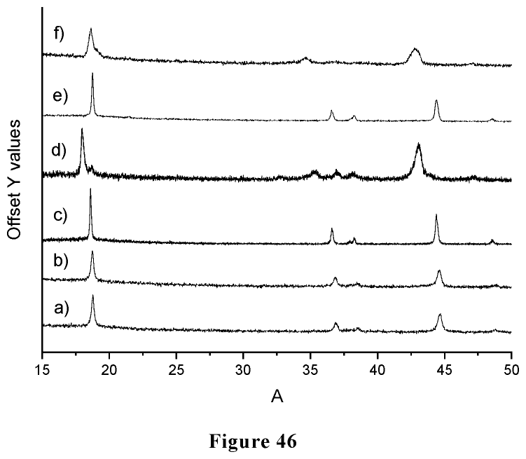

FIG. 46 shows X-ray diffraction patterns for a) NMC 111 after NaOH treatment, b) NMC 111 after hydrothermal treatment, c) NMC 622 after NaOH treatment, d) NMC 622 after hydrothermal treatment, e) NMC 811 after NaOH treatment, and f) NMC 811 after hydrothermal treatment.

In the figures, like or corresponding reference numerals are used for like or corresponding features.

The data discussed below and provided in the figures were obtained from a study conducted on Quality Control Rejected (QCR) cathode strips and end-of-life, used (EOL) cathode scrap (40,000 miles prior to disassembly). The cathode strips used for the majority of the tests described herein, both EOL and QCR, were mixed-phase LMO/Ni—rich layered oxide cathode strips. Any substantial differences between the EOL and QCR strips are therefore expected to be only due to degradation processes which occurred during use of the EOL strips, for example due to repeated cycling.

### Preparation of Electrode Material

In the embodiment being described, the selected electrode material is blended cathode strips from a Li-ion battery. Cells which were rejected by routine Quality Control (QC) were obtained directly from the manufacturer. These cells have mixed-phase cathodes, in particular LMO(spinel)/Ni rich layered oxide (e.g. NMC/NCA) cathodes. Used/End-of-Life cells (EOL) were obtained via the disassembly of an electric car battery, which was used for 40,000 miles of vehicle travel prior to disassembly.

The pouch cells were safely removed, cycled to gather other experimental data, and discharged prior to disassembly. The pouch cells were manually disassembled inside a ducted fume hood to separate the anode and cathode sheets. The open circuit voltages of the used (EOL) and QC-rejected (QCR) cells were 2.7 V and <1.0 V respectively. The cathode sheets were washed in Diethyl Carbonate (Sigma, 99%) and dried in a fume hood. The aluminium current collector was dissolved using a 10 wt. % solution of sodium hydroxide (Sigma, 97%). The cathode strip was filtered out of the resulting mixture, washed, and dried at 70° C.

It will be appreciated that electrode material may be extracted in other ways in other embodiments, with robotic disassembly currently being trialled, for example. Further, electrode strips obtained from battery shredding may be used in some embodiments.

FIG. 28 provides an outline of the overall method 2800 described in more detail below—it will be appreciated that sub-sections of this method 2800 may be used in isolation. The method 2800 comprises three main portions—leaching 2802 a mixed phase electrode material, synthesising 2806 a desired phase from the leachate, and synthesising 2808 a desired phase from the remaining, unleached, material. A simple filtering step 2804 may be used to separate the leachate from the unleached material, so providing two separate material streams.

### Leaching (2802) of Electrode Material

The mixed-phase battery electrode material (in the embodiment being described, a cathode strip) prepared as described above was then treated 2802 with a solution of an acid. The acid was selected to act as both a leaching agent and a reducing agent. An acid with a pKa greater than or equal to −2 was found suitable.

As a result of this treatment with the acid, a manganese-containing leachate is formed whilst leaving at least one phase of the battery electrode material unleached. This treatment may therefore be referred to as leaching of the cathode strip.

In many of the embodiments described below, the leaching was conducted using ascorbic acid (with molarities ranging from 0.1-1.25 M) at 70° C. for a given time period (1-60 minutes). Solid:liquid ratios of 1:40 (0.5 g electrode material to 20 ml of the acid solution) and 1:20 (0.5 g/10 ml) were tested. In alternative embodiments, a different temperature in the range from 15° C. to 100° C., optionally from 40° C. to 100° C., and further optionally from 50° C. to 90° C., may be used. It will be appreciated that equivalent conditions may be used for other suitable acids, such as citric acid.

It will be appreciated that, when a cooler temperature is used (e.g. less than 75° C., less than 60° C., less than 50° C., or less than 40° C., and optionally room temperature, which may be around 15° C. or 20° C.), a longer treatment time may be needed to perform sufficient leaching. For example, a time period of up to two hours, or optionally up to four hours, may be selected.

FIG. 29 illustrates X-ray diffraction patterns for a QCR cathode strip a) before the leaching treatment, b) after heating at 70° C. for 5 min. in an ascorbic acid solution, c) after dwelling at room temperature (−15° C.) in ascorbic acid for 1 hour, d) after dwelling at room temperature (−15° C.) in ascorbic acid for four hours and e) after dwelling at room temperature (−15° C.) in ascorbic acid overnight.

It can be seen from FIG. 29 that leaving the cathode strip in the acid solution for 4 hours or overnight at room temperature appears to fully remove the spinel. Small peaks associated with LMO are still present when left in the acid solution for only 1 hour. The data illustrate the removal of spinel with only the high Ni (x=˜0.8) layered oxide phase remaining. Leaching was deemed to be substantially complete after a room temperature treatment lasting two hours, making a longer treatment time unnecessary. Timings may vary in other embodiments, e.g. depending on cathode strip materials, cathode strip dimensions, and the selected acid solution.

Ascorbic acid was selected as the leaching acid for the first group of embodiments described in detail below as it is more environmentally friendly in comparison to other commonly used inorganic acids, such as H₂SO₄, HNO₃, HCl. Further, ascorbic acid possesses the additional benefit that it can also act as reducing agent in order to convert insoluble M³⁺ into soluble M²⁺, thus avoiding the need to add H₂O₂. Embodiments using citric acid are then also described. As a starting point for the ascorbic acid treatment, the following conditions were used: 1.25 M, 70° C., 30 minutes, 0.5 g in 20 ml of solution (solid to liquid ratio of 1:40).

Initial experiments using these conditions showed that this route led to the complete removal of the Mn-rich spinel while leaving behind the Ni—rich layered oxide phase. In order to see how quickly this could be achieved, a range of different processing times were investigated and the resulting strip was analysed with PXRD and XRF (as described below).

The ascorbic acid treatment of the embodiment being described may be complete in a matter of minutes (e.g. around 5 minutes using the conditions described below), removing the entirety of an Mn-rich phase, such as a predominantly Mn spinel phase, in that time. For Mn-containing materials with a lower % of Mn, a longer treatment time may be used, and/or less of the Mn-containing phase may be recovered in the same treatment time. As used herein, “Mn-containing” is used to refer in particular to phases with at least 20% Mn, as a percentage of the phase's transition metal content, as a manganese percentage of at least 20% was found to provide materials suitable for leaching by the techniques described herein. “Mn-rich” is used to refer to phases with at least 50% Mn, as a percentage of the phase's transition metal content.

Citric acid was used for the second group of embodiments described in detail below, as it shares many relevant properties with ascorbic acid. The listed examples were tested to investigate using citric acid to selectively leach LMO from mixed cathode materials. This LMO can then either be recovered or “upcycled” to form new cathode materials while the leftover cathode materials can then be regenerated before being reused in new Li-ion batteries. In prior studies (R. Golmohammadzadeh, F. Rashchi and E. Vahidi, Waste Manag., 2017, 64, 244-254; B. Musariri, G. Akdogan, C. Dorfling and S. Bradshaw, Miner. Eng., 2019, 137, 108-117; L. Yao, Y. Xi, H. Han, W. Li, C. Wang and Y. Feng, J. Alloys Compd., 2021, 868, 159222; B. H. Toby and R. B. Von Dreele, J. Appl. Crystallogr., 2013, 46, 544-549; I. Belharouak, W. Lu, D. Vissers and K. Amine, Electrochem. commun., 2006, 8, 329-335), citric acid has been used in combination with hydrogen peroxide, phosphoric acid, and/or relatively high temperatures. However, there is no reported use of citric acid for the selective recovery of specific materials from mixed cathode materials.

For the citric acid leaching investigations, a QCR cell and an EOL cell were examined. The cells were discharged and then manually disassembled to obtain the cathode sheets. The cathode sheets were then washed in diethyl carbonate before being dried in a fume hood. For the leaching, a specific amount of the cathode was added to 10 mL of 1M citric acid at 50° C. Leaching times of 5, 10, 15 and 20 minutes were then investigated. At the end of the specified leaching time, the solution was filtered 2084 to separate the remaining cathode from the citric acid solution. The cathode was put into an oven at 80° C. to dry while the solution was dried on a hotplate before being put into an oven at 200° C. for 4 hours. The remaining residue was ground by hand in a pestle and mortar and placed into an alumina crucible covered by a lid. This crucible was then put into a furnace at 700° C. for 6 hours.

This treatment (for both the ascorbic acid and citric acid examples described above) may therefore avoid one or more of: lengthy leaching procedures, the use of highly concentrated mineral acids, and the use of a separate reducing agent. Ascorbic acid (or citric acid) is able to fulfil both leaching acid and reducing agent roles and can be stored safely as a solid. This may not only lead to vastly improved safety, but may also reduce operating costs (e.g. no need for specialist storage, reduced processing time, etc.). As compared to ascorbic acid, citric acid offers generally the same advantages but is classed as an irritant—slightly more careful handling may therefore be appropriate with citric acid due to the eye irritation hazard, whilst remaining at a much lower hazard level than acids generally used in prior art hydrometallurgical procedures.

After the acid treatment (using whichever appropriate acid), a leached solution, or leachate, and the remaining unleached electrode material remain. These can be easily separated by filtration 2804, and the leachate and remaining strip both saved for further processing. In alternative embodiments, one of the leachate and the remaining strip may be kept and the other discarded, for example if recycling of one of the two split streams is not commercially viable.

The leached solution can be used to either recover/regenerate the leached Mn-containing phase (e.g. spinel) or to make new materials containing the leached elements. This may reduce waste processing costs as the leached solution is used in the resynthesis and may produce highly valuable electrode materials which can be processed to be used in fresh cells.

The remaining, unleached, electrode material (e.g. NMC or NCA) can be regenerated, e.g. through a hydroxide hydrothermal (“HH”) treatment, which may also degrade a binder such as PVDF. This may result in the production of a high value product that can be reused in fresh cells. In various embodiments, as described below, the treatment may utilise NaOH, leading to lower operating costs compared to routes that use LiOH.

All materials were characterised prior to and after leaching using either a Bruker D8 powder diffractometer (Cu Kα radiation) operating in reflection mode (ascorbic acid treated materials) or a Bruker D2 phaser with a Co radiation source (citric acid treated materials—measurements conducted in the range of 10-90° with a step size of ˜ 0.02°). The listed differences in analysis were primarily due to kit availability—both systems are PXRD instruments. FIG. 1 provides a representative example of XRD patterns for the materials prior to leaching. Variable-Temperature Powder X-Ray Diffraction (VT-PXRD) measurements were conducted for the ascorbic acid treated materials using a D8 fitted with an Anton Parr heating stage. For both groups of materials, Rietveld refinements were carried out using the GSAS suite of programs (see B. H. Toby, EXPGUI, a graphical user interface for GSAS, J. Appl. Crystallogr. 34 (2001) 210-213. doi:10.1107/50021889801002242, and A. C. Larson, R. B. Von Dreele, General Structure Analysis System (GSAS), Structure. 748 (2004) 86-748. doi:10.1103/PhysRevLett.101.107006). For the ascorbic acid treated materials, X-Ray Fluorescence (XRF) analysis was conducted using a Bruker S8 Tiger (best detection mode). For the citric acid treated materials, inductively coupled plasma atomic emission spectroscopy (ICP-AES, also referred to as inductively coupled plasma optical emission spectrometry (ICP-OES)) analysis was performed using an Agilent 5800 ICP-OES instrument. For both groups, SEM-EDX analysis was conducted using a Hitachi TM4000 plus benchtop SEM with AztecOne EDX analyser. Results from these analyses are presented below.

Table 1 below shows the refined unit cell parameter and phase fraction data for examples of the two cathodes (QCR and EOL). Both QCR and EOL cathodes have very similar lattice parameters for the LMO and LO phases. They also have similar amounts of LMO however the results indicate that the EOL cathode has more graphite and less LO (as opposed to a decrease in wt %, the loss of intensity of the LO phase could be due to the phase losing crystallinity).

FIG. 31 shows PXRD data for NMC622 before and after a ten-minute leaching treatment (1.25M ascorbic acid, S:L=1:20, 70° C.). The starting mass of the NMC622 sample was 0.35 g, and the end mass was 0.15 g, demonstrating leaching of 60% of the mass in just 10 minutes. As the data show no sign of secondary phase formation, it is expected that leaching would be complete in around 15 minutes.

Mn makes up just 20% of the transition metal content of NMC622, and the leaching time was correspondingly expected to be longer than that for materials such as LMO which have a higher manganese content (discussed elsewhere herein). The data illustrate that rate of leaching is dependent on the amount of Mn in the starting cathode. It has been shown that the cathode material can be successfully leached provided that the Mn concentration is ≥20% of transition metal content. Removal is time-dependant, but can be achieved in minutes. A maximum treatment time for the NMC111 to NMC622 series may be selected to be 20 minutes for QCR cathodes, or up to 40 minutes for used cathode materials. A longer treatment time of e.g. up to two hours may be used in some embodiments. Lower Mn-content phases such as NMC811, NCA, and LFP may remain unleached, and may then be regenerated by another method.

Experiments to investigate the effect of leaching time using the ascorbic acid solution were carried out by heating cathode material samples in 1.25 M ascorbic acid at 70° C. for 1-5 min. (QCR material) and 1-10 min. (EOL material). Each experiment used 0.5 g of cathode strip (CS) in 10 ml of the ascorbic acid solution. Cathode strip used in these experiments had been previously treated with NaOH in order to remove the Al current collector.

Results show a decrease in spinel (LMO) phase with increasing leaching time for both QCR and EOL CS (FIGS. 40 and 41; here, “0 min” refers to the material before the ascorbic acid treatment, but after treatment to remove the current collector). The weight fraction of the LO phase increases as expected with the decrease in LMO. An additional layered oxide phase is included for EOL refinements due to additional peaks observed in the XRD pattern (FIG. 42). Additionally, low intensity broad peaks (grey asterisk, FIG. 42) are observed in the XRD pattern for EOL CS (10 min), but not for the QCR CS. These peaks can be indexed with a rock salt phase.

Turning now to the use of other suitable acids, FIG. 34 shows XRD data obtained after leaching was performed on the QCR cathode using 10 mL of 1M citric acid at 50° C. (the current collector was not removed in advance in this test). The cathode was then left to leach for 5, 10, 15 and 20 minutes to investigate the influence of time upon the leaching process. A S:L (Solid:Liquid, i.e. cathode material:leaching solution) ratio of 30 g/L was investigated as a starting point (corresponding to 0.3 g of cathode material). FIG. 34 shows that the LMO phase is fully leached from the cathode by 20 minutes using a temperature of 50° C., as indicated by the two peaks at −42° becoming a single peak. At 5 minutes, the leaching has not completed, and the 10 and 15 minute patterns both show that there is still LMO present in the cathode. Both patterns have less intense LMO peaks than the starting cathode with the 15 minute pattern showing the least intense LMO peaks, suggesting that more LMO is leached as the leaching time increases. The LO phase remains throughout the leaching duration, indicating that it is not being leached into solution. Furthermore, by 20 minutes of leaching the remaining cathode had delaminated from the Al current collector. Therefore the leaching procedure can also act as a delamination step during recycling.

FIG. 35 shows SEM and EDX images of the QCR cathode before and after leaching for 20 minutes at 50° C. Before leaching, the QCR cathode has a reasonably even distribution of Mn across the surface with areas of lower Mn content corresponding to areas of high Ni content. The areas of high Mn content correspond to regions with LMO while the areas of high Ni content correspond to regions with LO. After leaching the SEM image shows voids across the surface of the cathode. These voids are areas where the LMO particles have been leached from the cathode. There is also a lower Mn content across the surface, and a more even distribution of Ni across the surface provides further evidence to support the conclusion that the LO remains during the leaching process.

The leaching of the EOL cathode was then investigated using the same conditions. The EOL cathode shows similar behaviour with the LMO being fully leached after a 20 minute treatment at 50° C. (see FIG. 36). This indicates that even after extensive cycling, LMO can be leached from the cathode material. The cathode also delaminated from the Al current collector, although by a lesser extent (˜25% of the cathode remained on the Al). After leaching, the XRD pattern has a shoulder on the peak at 22°. This shoulder is not seen for the QCR cathode suggesting that it is related to the additional cycling. It is known that cycling of LO can lead to a transformation from a layered oxide to a rocksalt structure. However, this shoulder does not appear to match a rocksalt phase, so may instead be due to another layered phase with slightly different lattice parameters being present, due to Li loss during operation

FIG. 37 shows SEM and EDX images of the EOL cathode before and after leaching for 20 minutes. The SEM images are different from that of the QCR cathode, showing larger particles consisting of agglomerations of smaller particles. The EDX images show discrete regions of Mn and Ni before leaching and then a much lower Mn and higher Ni content after leaching. Once again this supports the conclusion that LMO is leached from the cathode, leaving LO behind.

ICP-OES analysis was then performed on the leaching solution. FIG. 38 shows that similar amounts of Li and Mn were leached from both the QCR and EOL cathode material. It also indicates that 20 minutes at 50° C. is the optimum leaching time for this material, as by 25 minutes no more Li/Mn is leached. The amounts leached correspond to the expected amounts from the refinement data collected (discussed above).

Citric acid can therefore also act as a selective leaching agent to remove LMO from mixed cathode materials containing LMO and a layered transition metal oxide. 1M citric acid at 50° C. was found to leach 30 g/L of cathode material in 20 minutes. This method has been confirmed to work for both QCR and EOL cathode materials. XRD patterns showed increased removal of the LMO phase with increased leaching time (up to around 20 minutes) while SEM and EDX images showed removal of Mn from the cathode surface upon leaching. ICP-OES analysis showed that the expected concentrations of Li and Mn were leached from the cathode material as predicted by refinement data. Citric acid also acts as a delamination agent to (at least partially) remove the remaining cathode from the Al current collector (it will be appreciated that other suitable acids may also provide this benefit).

In general, an S:L ratio may be selected such that at least 10 ml of liquid is provided per gram of solid (electrode material), i.e. an S:L of 1:10+, and optionally at least 13 ml of liquid per gram (0.75 g:10 ml, S:L=1:13), may be used, with optimal values varying for different leaching solutions (e.g. different acids and/or different concentrations). For the solutions described herein, the citric acid solution was found to provide the best results at an S:L ratio of 1:33 (0.3 g in 10 ml). At 1:25 (0.4 g in 10 ml) the precipitate started to appear. By contrast, the ascorbic acid solution was found to provide the best results at an S:L ratio of around 1:20 (0.5 g in 10 ml), and the precipitate started to form at around 1:13 (0.75 g/10 ml).

Synthesis (2806) of Desired Phase from Leachate
In the embodiments being described, the desired phase to be synthesised 2806 from the leachate is a Spinel or LO phase (e.g. an NCA or NMC phase)—the skilled person would appreciate that this may vary based on both the starting electrode material, and therefore the extracted phase, and also the desired end product. If spinel is made, this process may be described as resynthesis 2806, as, in the embodiment being described, the phase removed from the electrode material by leaching was a spinel phase and this is being re-formed.

In various embodiments, this synthesis comprises re-generating the originally-leached phase (e.g. an LMO phase) from the leachate, by: drying the leachate so as to form a precipitate; grinding the precipitate; and annealing the ground precipitate in air.

In some cases, especially for end-of-life cells, an additional source of relevant metal ions (e.g. Na, Li) may be ground with the precipitate to replace ions lost in use.

For example, in the present embodiments, to synthesise 2806 the spinel phase from the leached solution, the leachate was evaporated and dried at 150° C. overnight to form a honeycomb-like precipitate. The precipitate was retrieved and ground before annealing in air at 700° C./12 hs/100° Ch⁻¹. If Li (or Na, for Na-ion batteries) has been lost, e.g. due to degradation in use, additional metal ions may need to be added to replace those lost. The resulting material was re-ground and then heated at 350° C. for 1 hour, with a 0.5° C. min⁻¹ heating and cooling rate. It will be appreciated that this heat treatment step is a common step conducted in sol-gel synthesis.

In other embodiments, this synthesis comprises generating a different phase (e.g. an X-NMC phase) from the originally-leached phase, using useful leached metal ions. For example, to create an XNMC phase such as LiNiₓMn_{y}Co_{z}O or NaNiₓMn_{y}Co_{z}O, in various embodiments the synthesis is performed by gravimetrically determining an amount of material lost from the mixed-phase battery electrode material into the leachate; and adding a stoichiometric amount of one or more reagents to the leachate to introduce desired metal cations, so as to generate a desired battery cathode material.

In various embodiments, this involves gravimetrically determining the amount of the leached phase in the leachate from the change in mass of the electrode material, and, based on the gravimetrically determined amount: calculating a molar amount of a cobalt—and nickel-containing sulfate, M(SO₄)—nH₂O (where M=Co and Ni), required to obtain the target XNMC composition from the leachate; and calculating a molar amount of a carbonate or hydroxide of X required to obtain the target XNMC composition from the leachate.

The calculated amount of M(SO₄)—nH₂O is then combined with the leachate; and a stoichiometric molar amount of a soluble source of barium (e.g. barium acetate—Ba(C₂H₃O₂)₂) calculated from the molar amount of M(SO₄)—nH₂O and the Co:Ni ratio of M is added to the leachate solution to trigger the precipitation of BaSO₄ so as to remove the sulfate from the leachate solution. It will be appreciated that a different cation, e.g. calcium or strontium, may be used in place of barium. The leachate solution is then dried by evaporation to form a precipitate, and that precipitate is ground with the calculated amount of a carbonate or hydroxide of X (e.g. LiOH—H₂O). The resultant ground material is then annealed in air.

In the present embodiment, in order to synthesise NMC from the leached solution of LMO, the amount of dissolved spinel was gravimetrically determined and the molar amount of M(SO₄)—xH₂O (where M=Co and Ni) was added to the solution to obtain the target NMC composition. In order to remove sulfates from the solution, Barium acetate (Ba(C₂H₃O₂)₂) was added to the solution to trigger the precipitation of BaSO₄ (amount determined from the molar ratio of the metals used). The BaSO₄ was removed through filtration and the remaining solution was treated similarly to the synthesis route outlined elsewhere for the LMO spinel (including grinding the precipitate and then heating it at 350° C./1 h/0.5° C. min⁻¹ as described below), although with the addition of the required amount of LiOH—H₂O and a higher final annealing temperature (850° C./12 hs/100° Ch⁻¹/air). Any organic components (such as acetates introduced with the Ba(C₂H₃O₂)₂ will burn off in the annealing phase, leaving only the desired inorganic components.

In the embodiment being described, barium acetate was selected as a soluble source of barium as the produced BaSO₄ is insoluble and not toxic. In other embodiments, a different reagent, and indeed a different metal ion, may be selected provided that it is suitable to form an insoluble sulfate, for ease of removal. In further alternative embodiments, Co— and Ni-containing acetates, Co and Ni-containing nitrates, or similar, may be used to provide the desired Co and/or Ni without introducing sulfates which then need to be removed. However, a relatively large amount of gas released by that route could interfere with the carbon intermediate formed at the 350° C. heating step (in particular, control and scalability issues may arise as the precipitate can ‘grow’ substantially when using nitrates), and the acetates may also be more expensive. Adding and later removing the sulfate may therefore reduce the overall emissions of the process.

In other embodiments, in order to synthesise NMC from the leached solution of LMO, after the addition of the required metals to the solution to synthesise the target NMC phase, a hydroxide source (e.g. NH₄OH/NaOH) is added to the solution to trigger the precipitation of the target NMC(OH)₂. The solution is then filtered and washed thoroughly. Once dried (at ˜70° C.), the precipitate is then ground with a lithium source (Li₂CO₃/LiOH—H₂O) and annealed at 850° C. for 1 to 12 hours. The remaining solution can be retained in order to attempt Li recovery (e.g. carbonate recovery using Na₂CO₃, evaporation and heating to potentially yield Li₂CO₃, or any other suitable route known to one skilled in the art).

FIG. 32 provides PXRD data for NMC532 synthesised from the precipitation of NMC532(OH)₂ from a solution containing leached spinel from cathode strips, using this method. Plot (a) illustrates NMC532 synthesised from a QCR cathode strip, and plot (b) illustrates NMC532 synthesised from an EOL cathode strip. For the experiments performed, stoichiometric amounts of reagents were calculated and added due to relatively small volumes used; the reagents may be added until precipitation occurs once pH=11 in other implementations of this method.

In other embodiments, any battery material that contains Mn and Li may be used instead of the specific cathode strip of the embodiment being described. In various embodiments, electrode materials with a reasonable amount of Mn in the target material are found most suitable, for example at least 15% of the transition metal content in the target phase may be manganese, and optionally at least 20% or 25%. In some embodiments, Mn may form 30% of the transition metal content in the target phase.

For NMC compositions, the three numbers indicate the Ni:Mn:Co ratio—NMC532 therefore has a Ni:Mn:Co ratio of 5:3:2 whereas NMC811 has a Ni:Mn:Co ratio of 8:1:1. NMC compositions with at least as high an Mn content as NMC532 or NMC622 (20%), and also LiMnNiO spinels are deemed particularly suited to the leaching and regeneration process described herein, as well as various recent materials capable of oxygen redox (these being predominately Mn-based).

Lithium nickel cobalt aluminium oxides (NCA) may contain a small amount of Mn and may be synthesized using the approach described herein; however the ratios may not necessarily make the route viable (in particular due to the costs associated with the addition of pristine materials to provide the desired metal ions).

### Regeneration (2808) of Remaining Electrode Material

In various embodiments disclosed herein, the remaining phase in the cathode strip after leaching is a layered oxide (LO), of which NMC and NCA are examples. The LO phase may be treated hydrothermally to regenerate it. In the specific embodiment described in this section, the remaining phase in the cathode strip after leaching is NMC, and in particular an NMC layered oxide (LO) phase. In alternative embodiments, other LO materials may be present in the leached cathode strip and treated in the same way—for example high Ni-content cathode materials based on Lithium Nickel dioxide LNO, and/or a Li-rich layered oxide phase such as NCA. In various embodiments, the remaining phase(s) may each have a Mn content of less than 20%, optionally less than 10% or 15%, and further optionally 0%.

In the embodiment being described, the remaining NMC layered oxide (in the cathode strip) was recovered (0.1-0.2 g per treatment) and added to a 23 ml Teflon container in a Parr Hydrothermal vessel containing 10 ml of 0.5-1M NaOH (aq.). The hydrothermal vessel was heated overnight at 160° C. for 2-12 hours to form the NMC(OH)₂. This hydrothermal treatment with a hydroxide may be referred to as a hydrothermal hydroxide treatment (HH). The resulting powder was filtered, washed and dried. The recovered hydroxide powder was heated with LiOH—H₂O to resynthesise NMC using the same conditions as referenced above.

In particular, the HH treatment for regenerating the unleached phase comprises: forming a hydroxide of the unleached phase—in the embodiment being described, this is done by treatment with 0.5-1M NaOH and heating to 160° C. for 2-12 hours; grinding the hydroxide of the unleached phase with a stoichiometric amount of a hydroxide of the desired metal ion (e.g. LiOH—H₂O for a Li-ion battery material, or NaOH—H₂O for a Na-ion battery material)—in the embodiment being described, this is done by grinding with LiOH—H₂O; and heating the resultant powder to resynthesise the original phase. In the embodiment being described, the resultant material is annealed at 850° C. for 12 hours in air (a time period of between 1 and 12 hours, in air or an atmosphere of/including oxygen, may be used in other examples), with a heating rate of 100° C. per hour, to resynthesise the original phase. A shorter treatment time, optionally at a higher treatment temperature, may be used in other embodiments.

In another example, the remaining material of an EOL-CS after ascorbic acid leaching is treated hydrothermally to regenerate the layered oxide phase. The remaining cathode strip was heated in NaOH in a hydrothermal vessel at 160° C. for 12 hours. Samples were filtered and dried at 70° C. for 12 hours, before adding a calculated amount of LiOH·H₂O or Li₂CO₃ (to make up for lifetime losses) and heating the material to 850° C. for 12 hours. More specifically, the hydroxide precipitate was heated with Li₂CO₃ (10% excess) to 850° C. for 12 hours to obtain the XRD data shown in FIG. 45).

It will be appreciated that this HH process could be applied to differently-obtained NMC, or indeed to a different layered oxide material, if there is a desire to regenerate it, whether or not it has been leached 2802 beforehand. In these cases, the Ni content is important to consider due to hydroxide formation being favoured in systems where Ni≥60% of the transition metal content, whereas for lower Ni contents, a mixed oxide/hydroxide generally forms. In particular, whilst the approaches described herein provide good separation when one phase is mostly Mn and the other is mostly Ni (Mn removed by leaching, Ni phase regenerated via the hydroxide), if two or more NMCs, with similar compositions were present, the separation may be less effective. Some consideration of feedstock may therefore be performed to check likely outputs of the approaches described herein, as the phase selectivity will not be as effective for more similar phases. Nonetheless, a leachate with a mixture of similar phases may be more easily recycled/regenerated than a leachate containing all of the original (potentially disparate) phases/a wide variety of phases, so the processes described herein may still be of utility even when two or more very similar phases are present in a feedstock containing a plurality of phases. XRD data shown in FIG. 46 indicate that the higher Ni content phase (NMC 811) forms the hydroxide phase while the lower Ni content NMC 111 remains as the layered oxide phase. The intermediate Ni-content example, NMC 622, appears to form a mixture of the layered oxide and the hydroxide phase. Initial data therefore suggest that hydrothermal treatment has a different effect depending on Ni content where complete formation of the hydroxide phase occurs where Ni content≥0.6. The current trend is for higher Ni contents in electric vehicle batteries (Ni≥0.8): therefore the formation of the hydroxide phase would be seen on recycling such cathodes.

Further results of the study outlined above are described below, with reference to FIGS. 1 to 27.

### CHARACTERISATION of the Electrode Material Prior to Leaching

After manually dismantling the pouch cell, the current collector was dissolved using sodium hydroxide (NaOH) in order to liberate the cathode strip for leaching. In other embodiments, this step may be replaced with a different removal process, such as a delamination process in which the strip is etched from the surface (e.g. by the acid leaching treatment itself) and the Al current collector preserved. However, in order to reduce potential Al contamination during regeneration/resynthesis and to focus processes primarily on cathode dissolution, in the embodiments of the process described below the current collector was dissolved and the remaining strip was filtered out, washed and dried thoroughly before further treatment.

The electrode material (more specifically in this embodiment, the strip containing the cathode phases) was characterised using PXRD prior to any leaching (but after the removal of the current connector, which in this case was made of Al). The results, presented in FIG. 1, show that the expected phases remain unchanged after the hydroxide treatment for current collector removal and are comparatively similar between QCR and EOL cathode materials, although the graphitic content is larger in the used cathode strip. EOL (note that the wt % is only applicable to crystalline phases and does not include the amorphous carbon/binder added during coating).

In particular, FIG. 1 illustrates PXRD plots 102, 104 for EOL (darker grey—102) and QCR (lighter grey—104) cathode strips. Markers 106 are used to indicate which peaks correspond to which phase, with black markers 106 indicating locations of layered oxide (LO) peaks, dark grey markers indicating locations of spinel (SP) peaks (LMO), and light grey markers indicating locations of graphite peaks. FIG. 1 shows that both cathodes (QCR and EoL) contain the expected mixture of materials along with graphite. All of the diffraction peaks in the patterns can be indexed based on the LMO (Fd3̅ m space group), LO (R3̅ m space group) and graphite structures (P6₃m̅ space group).

FIG. 2 illustrates the same PXRD plot 102 of experimental data for EOL shown in FIG. 1 overlain by a calculated plot for the material—the overlap is close enough for the two lines not to be easily distinguishable at the resolution shown, and the difference line 103 confirms that the calculated data are a close match to the experimental data. The background line 107 is shown for reference. The same markers 106 as used in FIG. 1 are shown for ease of reference.

FIG. 3 illustrates the same PXRD plot 104 of experimental data for QCR shown in FIG. 1 overlain by a calculated plot for the material—the overlap is again close enough for the two lines not to be easily distinguishable at the resolution shown, and the difference line 103 confirms that the calculated data are a close match to the experimental data. The background line 107 is shown for reference. The same markers 106 as used in FIG. 1 are again shown for ease of reference. Various parameters of these materials are summarised in Table 1:

TABLE 1
Cell parameters and weight percent of phases in QC-rejected
and EOL cathode strip after Al dissolution

| | | | | Cell | | |
|---|---|---|---|---|---|---|
| Con- | | | | vol. | wt | Parameters |
| dition | Phase | a (Å) | c (Å) | (Å³) | % | of fit |
| QC- | Spine1 | 8.2032(1) | — | 552.01(3) | 68 | χ² − 1.673, |
| re- | Layered | 2.8710(2) | 14.2485 | 101.71(1) | 29 | wRₚ-2.53%, |
| jected | Oxide | | (9) | | | Rₚ − |
| | Graphite | 2.427(5) | 6.717(3) | 34.3(1) | 3 | 1.90% |
| EOL | Spine1 | 8.2028(2) | — | 551.94(4) | 62 | χ²- 1.825, |
| | Layered | 2.8523(2) | 14.288(1) | 100.67(1) | 24 | wRₚ − 2.17%, |
| | Oxide | | | | | Rₚ − |
| | Graphite | 2.4551(5) | 6.7121(6) | 35.04(1) | 14 | 1.69% |

Characterisation of the Electrode Material after Leaching

Using the leaching 2802 conditions of: 1.25M ascorbic acid solution, 70° C., 30 minute treatment time, 0.5 g of electrode material in 20 ml of solution (solid to liquid ratio of 1:40), the XRF and PXRD results shown in FIGS. 4 and 5 were obtained for QCR electrode materials (cathode strips). These initial experiments showed that this route led to the removal of the Mn-rich spinel completely while leaving behind the Ni—rich layered oxide phase. In order to see how quickly this could be achieved, a range of different processing times were investigated and the resulting strip was analysed with PXRD and XRF. The data suggest that the spinel phase can be removed in as little as 3 minutes using the conditions outlined above. This short treatment time may facilitate subsequent direct regeneration of the remaining cathode material, as the spinel phase (or other Mn-containing phase, in other embodiments) can be removed quickly and efficiently without significant damage to the remaining cathode material (in particular, no obvious changes to the diffraction pattern of the remaining layered oxide were seen, which is in stark contrast to earlier studies which have seen extensive delithiation of the remaining layered oxide when trying to selectively remove one phase).

FIG. 4 (XRF data) illustrates how weight percentages of three key elements—nickel, manganese, and cobalt—in the remaining, unleached strip change with time, ranging from immediately after the removal of the aluminium (prior to leaching—treatment time is zero) to after a 30 minute treatment time. In particular, data are shown for treatment times of 0, 1, 2, 3, 5, 10, 20, and 30 minutes, respectively from left to right, for each element. It can be seen that the proportion of manganese drops rapidly, before approximately stabilising after three minutes. This indicates than one or more Mn-rich phases are being removed rapidly, leaving Ni as a more prominent constituent of the remaining cathode strip. The drop in wt. % of Ni after a treatment time of more than 10 minutes indicates that a different, more Ni—rich, phase may start to be lost over a longer treatment time.

FIG. 5 provides PXRD data at the same intervals, with the zero-minute treatment time (i.e. properties of the cathode strip prior to leaching) plot 104 shown as the lowest plot, with treatment increasing sequentially for the higher plots. Markers 106 again indicate which peaks correspond to which phase, although in this figure black markers 106 indicate locations of graphite peaks, dark grey markers indicate locations of spinel (SP) peaks, and light grey markers indicate locations of layered oxide (LO) peaks.

SEM-EDX analysis was also conducted to further probe the leaching process 2802 (see FIGS. 6 and 7). Prior to leaching, the cathode strip shows clear differentiated Mn— and Ni—rich domains which correspond to LMO (spinel) and Layered Oxide (LO) phases respectively. The Co that is present in the sample appears to reside within the layered oxide suggesting either NCA or an NMC-type cathode material. FIG. 6 shows an SEM image 600 of the cathode strip prior to leaching, and three EDX elemental mappings 602, 604, 606 for Ni, Mn, and Co, respectively. FIG. 7 shows an SEM image 700 of the cathode strip prior to leaching, and three EDX elemental mappings 702, 704, 706 for Ni, Mn, and Co, respectively.

After leaching, in this case with a five minute treatment time, voids are clearly visible in the electrode strip, as can be seen by comparison of the SEM image 600 taken before leaching and the SEM image 700 taken after leaching. Further, rather than clearly distinct Mn and Ni domains as seen prior to leaching, the remaining Ni, Mn and Co all appear to be located in the same place suggesting that only the layered oxide remains within the carbon-polymer framework of the cathode strip. This is consistent with removal of the spinel phase—i.e. phase-selective leaching has occurred.

Equivalent characterisation and analysis was performed for EOL cathode strips sourced from a used electric car battery, using the same procedure. The results are shown in FIGS. 8 and 9. FIG. 8 provides PXRD data for ascorbic acid leaching treatment periods of 0, 3, and 5 minutes, with the zero-minute treatment time (i.e. properties of the cathode strip prior to leaching) plot 102 shown as the lowest plot, and treatment increasing sequentially for the higher plots. Markers 106 again indicate which peaks correspond to which phase, although in this figure the lightest grey markers 106 indicate locations of graphite peaks, darkest grey markers indicate locations of spinel (SP) peaks, black markers indicate locations of a first layered oxide (LO1) phase peaks, and the medium grey markers indicate locations of peaks for a second layered oxide phase (LO2), as discussed below.

FIG. 9 (XRF data) illustrates how weight percentages of three key elements—nickel, manganese, and cobalt—in the remaining, unleached strip change with time, comparing the QCR and EOL strips for three treatment times (0 minutes, 3 minutes, and 5 minutes). Unlike the QC-rejected material, there appears to be a small amount of spinel remaining after a 3-minute treatment of the EOL cathode strips. By increasing the treatment time to 5-minutes, the spinel can be removed completely (confirmed by the PXRD and XRF data shown in FIGS. 8 and 9). A notable observation in the PXRD data for the EOL cathode strip is that, after the spinel phase has been removed, a shoulder appears on the peak at ˜19° 2-Theta. Although it is difficult to say with certainty from PXRD data alone, it is hypothesised that this shoulder can be attributed to a second layered oxide (LO2) phase associated with degradation processes. Indeed, when such a second phase was introduced into the refinement, a good fit to the data was obtained. The cell parameters for the two phases are shown in Table 2:

TABLE 2
Cell parameters and weight percent of phases in EOL cathode strip
after Al dissolution and a 5-minute leach treatment with ascorbic acid.

| Con- | | | | Cell vol. | wt | Parameters |
|---|---|---|---|---|---|---|
| dition | Phase | a (Å) | c (Å) | (Å3) | % | of fit |
| EOL- | Spine1 | 8.2032(1) | — | 552.01(3) | 68 | χ² − 1.673, |
| 0 min. | Layered | 2.8710(2) | 14.2485 | 101.71(1) | 29 | wRₚ − 2.53%, |
| | Oxide | | (9) | | | Rₚ − 1.90% |
| | Graphite | 2.427(5) | 6.717(3) | 34.3(1) | 3 | |
| EOL- | Layered | 2.8590(8) | 14.246(1) | 100.84(1) | 77 | χ² − 3.553, |
| 5 min | Oxide (1) | | | | | wRₚ − 2.23%, |
| | Layered | 2.872(3) | 13.872(3) | 99.1(2) | 9 | Rₚ − 1.60% |
| | Oxide (2) | | | | | |
| | Graphite | 2.3928(6) | 6.7171(8) | 33.31(1) | 14 | |

The second layered oxide phase (LO2) present shows a smaller c-parameter compared to that of LO1, consistent with the shoulder appearing to the right of the (003) peak. This suggests that metal migration may have occurred causing layer pinning to occur (Li⁺-0.76 Å, Ni²⁺-0.69 Å, Ni³⁺—0.56 Å/LS, 0.6 Å/HS) which is a common degradation mechanism observed in layered systems consisting of predominately Ni. Of note is the decreased Mn concentration in the EOL sample when compared to a QCR sample; this may be due to surface dissolution of Mn during operation.

SEM-EDX analysis was also conducted on the EOL sample before (FIG. 10) and after (FIG. 11) treatment (5 minute treatment time). As with the QC-rejected sample, the EOL sample shows clear Mn-rich and Ni—rich domains that can be attributed to LMO and LO respectively. A notable difference in the EOL cathode strip is that the smaller Ni—rich LO particles appear to agglomerate, forming partial spheres amongst the larger spinel particles. After treatment 2802 with ascorbic acid, only trace amounts of Mn are observed in the sample, which appears to be in the same region as Ni and Co. These data support the previous observation that the spinel phase has been successfully leached, leaving behind a Ni—rich phase which can then be directly recycled.

### Refinement of Ascorbic Acid Treatment

A number of variables were refined in order to improve the leaching process 2802.

For QCR cathode strips, the concentration of the ascorbic acid solution was varied in the range from 0.25M-1.25M while keeping other variables constant; it was found that a solution pH of 0 was best-suited to obtaining reliable and complete leaching of the spinel phase (this is consistent with the relative stabilities of transition metals in solution as Mn²⁺ is the most stable oxidation state for Mn in acidic media, and is therefore expected to apply to other Mn-containing phases). In the embodiment being described, the concentration of the acid solution was therefore maintained at 1.25 M. Testing with lower concentrations also suffered from reproducibility issues, whereas a concentration of 1.25 M consistently leached the spinel. FIG. 12 illustrates, from left to right, elemental compositions of Mn, Ni and Co: prior to treatment, following treatment with a 0.25 M ascorbic acid solution, following treatment with a 0.5 M ascorbic acid solution, following treatment with a 0.75 M ascorbic acid solution, following treatment with a 1.0 M ascorbic acid solution, and following treatment with a 1.25 M ascorbic acid solution, respectively.

The effect of solid:liquid ratio was also evaluated using QCR cathode strips. The masses of cathode strip were varied from 0.5 g-1.5 g while using 20 ml of 1.25M ascorbic acid. The maximum amount of strip that can be successfully treated with these conditions, without deleterious side effects, was found to be 1 g in 20 ml (a solid:liquid ratio, S:L, of 1:20), increasing the strip mass further causes an insoluble orange precipitate to form after treatment (FIG. 13). In particular, FIG. 13 shows a photograph of solutions showing the precipitate that forms with increasing S:L. Four beakers 1300, 1302, 1304, 1306 are shown. The left-most beaker 1300 contained 0.5 g of strip (S:L=1:40), the next beaker 1302 contained 0.75 g of strip (S:L=1:27), the third beaker 1304 contained 1.0 g of strip (S:L=1:20), and the right-most beaker 1306 contained 1.5 g of strip (S:L=1:13), all added to 20 ml of the acid solution. Total content volumes vary slightly between beakers due to filtering/washing. In the experiments described herein, 0.5 g of cathode strip in 10 ml of the acid solution (an S:L ratio of 1:20) was used except where specified otherwise.

The presence of the precipitate could cause issues during the regeneration step described in more detail below, as the amount of spinel in solution is determined gravimetrically by weighing the strip before and after treatment—the presence of a precipitate would make this determination inaccurate for the solution, and so conditions were selected to reduce or avoid the formation of this precipitate.

After determining the optimum conditions using QCR strips, the same procedure was attempted using the EOL strip (0.5 g/10 ml, S:L=1:20). However, the treatment time found to be ideal for QCR strips was shown not to be sufficient to remove all of the spinel from the EOL strips. By increasing the treatment time from 5 to 10 minutes, all of the spinel was removed from the EOL strip (FIGS. 14 and 15). FIG. 14 (XRF data) illustrates, from left to right, weight percentages of Ni, Mn, and Co immediately after removal of the Al/prior to leaching (“NaOH treatment”), after a 5 minute treatment with 20 ml of 1.25 M ascorbic acid, after a 5 minute treatment with 10 ml of 1.25 M ascorbic acid, and after a 10 minute treatment with 10 ml of 1.25 M ascorbic acid. FIG. 15 (PXRD data) illustrates plots for the same, from bottom (prior to leaching, 102) to top (after a 10 minute treatment with 10 ml of 1.25 M ascorbic acid).

Therefore, the following conditions were established for reproducible selective leaching of spinel from the cathode strip: 1.25M ascorbic acid solution, 70° C., 10 ml of acid, 0.5 g of cathode strip after Al dissolution (solid to liquid of 1:20), 10 minutes for used cathode strips (EOL) and 5 minutes for unused, QCR, cathode strips.

### Recycling (2806) of the Leachate—Experimental

In the embodiment being described, the manganese-rich phase leached from the cathode strip is a spinel phase—LMO (Lithium Manganese Oxide, LiMn₂O₄). The below example method is therefore described primarily in terms of an LMO-containing leachate, although the skilled person would appreciate that different phases may be leached in other embodiments. Two example recycling routes for the LMO-containing leachate are described by way of example: regeneration of LMO and synthesis of NMC.

In order to determine how much spinel was removed from the cathode strip (CS) after each leaching treatment, the strip was weighed before and after treatment and dried to a constant weight. The weight % of the spinel corresponds to ˜70 wt. % of the total mass of the (unleached) cathode strip (FIG. 16). The mass of spinel in the leachate is therefore gravimetrically determined as the mass lost from the cathode strip after leaching.

The treatment proved to be extremely reproducible, as indicated by the narrow error bars shown in FIG. 16 (±0.5 wt % for QCR samples (4 repeats), ±1.2% for EOL (16 repeats)), therefore the leached mass was used to determine how much Li, Ni and Co was required to make the target NMC composition. If the aim is to regenerate the spinel phase (LMO), no additional metals are generally required and the solution can be simply processed through a sol-gel procedure. However, some additional Li may be required due to degradation reactions—assessing battery capacity prior to disassembly may provide an indication of how much degradation has occurred.

In the embodiment being described, the leachate solution was heated to 150° C. overnight to produce a ‘honeycomb’-like precipitate. This precipitate was then intimately ground with a Li source (such as LiOH) and then heated at 350° C./1 h/0.5° C. min⁻¹, retrieved and reground, before a final annealing process at a temperature of 700° C./12 hs/1.7° C. min⁻¹ to re-form a spinel phase. It will be appreciated that variations on these conditions can be made as appropriate by the person skilled in the art; for example, when recovering LiMn₂O₄ from ascorbic acid leached solution resulting from the process described with respect to FIGS. 40 to 42, the ascorbic acid leached solutions at 5 min (QCR) and 10 min (EOL) were collected and dried at 130° C. for 12 hours before a heat treatment to 700° C. for 12 hours, after addition of a suitable amount of an Li source to account for possible degradation (as for the spinel resynthesis, both Li and Mn are leached from the spinel phase of the cathode strip so the majority of the Li needed for regeneration should be present. However, due to degradation processes in use of an EOL-CS, a small amount of extra Li may be added to account for this loss, to fully regenerate the material). XRD patterns of regenerated spinel materials for these QCR and EOL leachates are provided in FIG. 43.

In addition to, or instead of, regenerating LMO, the leached solution can be used to “upcycle” to NMC or another layered oxide material. If the target is instead to make a new NMC phase; for example, to make LiNi_{0.33}Mn_{0.33}Co_{0.33}O₂(NMC111) from the leached solution, additional metals are provided, for example in the form of appropriate metal sulfates and/or hydroxides. In the case of NMC111, the desired molar ratio of Li:Co:Ni would be 6:2:2 assuming the spinel was LiMn₂O₄(the Li originally in the spinel is used to replace the pristine excess that would normally be required when synthesising phase pure NMC due to Li volatility, so the proportion of Li in the added material is selected to be equal to the proportion in the desired NMC composition). Different ratios may be selected depending on the desired NMC phase.

In the embodiment currently being described, the metals are added in the form of sulfates, and the solution is then thoroughly stirred and treated with Barium Acetate (Ba(C₂H₃O₂)₂) to trigger the precipitation of Barium sulfate (BaSO₄) which is removed from the mixed solution via filtration. Sulfates were selected and removed in this embodiment rather than using the equivalent metal nitrates in order to reduce potential emissions for the process as nitrates decompose to form NO, when heated in air. After the precipitation of Barium sulfate, the remaining solution was then heated to 150° C. overnight to produce a ‘honeycomb’-like precipitate. The acid solution used for the leaching may therefore facilitate this synthesis. This precipitate was then intimately ground with a Li source (such as LiOH) and then heated at 350° C./1 h/0.5° C. min⁻¹, retrieved and reground, before a final annealing process at a temperature of 850° C./12 hs/1.7° C. min⁻¹ to form NMC.

It will be appreciated that once a leached solution has been acquired, a desired LO phase (e.g. NMC 532) can be synthesised by a variety of different routes, of which two examples are presented below. For both methods, the amount of dissolved spinel is gravimetrically determined and the corresponding molar amount of the desired metals, M (where M=Co and Ni) is added to the solution, generally in the form of a sulfate: M(SO₄)·xH₂o. Nitrates, acetates, and/or other soluble metal ion sources may be used in some implementations—the use of sulfates is often preferred due to ease of use and removal, and to avoid the unwanted gas release on decomposition of nitrates and acetates. The next step is determined by the route which is selected to synthesise the LO phase:
Route A (Hydroxide route)—NaOH, or another suitable OH⁻ source, is added to cause NMC(OH)₂, or an equivalent mixed-metal hydroxide (depending on the starting material) to precipitate out of solution; this precipitate is then filtered and dried (e.g. at 100° C. for 12 hours). A Lithium source (e.g. LiOH·H₂O or Li₂CO₃), or an equivalent Sodium source as applicable to the desired end product, may be added before a final heat treatment (e.g. 850° C. for 12 hours), forming a layered oxide. Route A is unaffected by the source of transition metals (e.g. sulfates, nitrates, acetates) as the counter-ion remains in the solution and can then be disposed of later.
Route B (Sulfate exchange route—this may also be referred to as a sol-gel route)—in implementations using a sulfate counter-ion for the M addition, a soluble Barium ion source such as Ba(C₂H₃O₂)₂ is added in order to remove the sulfates, by causing BaSO₄ to precipitate out of the solution. A different cation, such as Ca or Sr, or even Pb, may be used in place of Ba for the sulphate exchange in other examples; importantly, the cation source should be soluble in the leachate and form an insoluble sulfate. The BaSO₄ (or equivalent sulfate) is removed through filtration and the remaining solution heated to 130° C. for 12 hours. A Lithium source (e.g. LiOH·H₂O or Li₂CO₃), or an equivalent Sodium source as applicable to the desired end product, may then be added, before heating to 350° C. for 1 hour. Finally, the material is re-ground and heat treated (e.g. at 850° C. for 12 hours). Unlike in Route A, sulfate has to be removed as the whole solution (containing Li/Mn/Ni/Co etc.) is dried and then heated to form the layered phase precursor, so any remaining sulfates would lead to the creation of impurities (e.g. Li₂SO₄). In implementations in which the M-acetate, nitrate, or similar is used, Route B could be applied without having to do the extraction (as no sulfate is present), however gas release on decomposition of the acetates/nitrates, control and emissions may introduce other complexities, so use and removal of the sulfate may be preferred.

According to the present disclosure, the regeneration of the cathode material can therefore be obtained through either of two routes; the selected route may depend on life cycle analysis (LCA) requirements (e.g. emissions, ease of synthesis, reagent availability, waste disposal considerations etc.) and/or other considerations. In the example described above (an example of Route B), once the required metals have been added to the solution in the form of sulfates, barium acetate is added to remove sulfates and a precipitate is obtained and ground thereafter. If Route A is selected instead, the required metals are added to the solution in any suitable form (e.g. sulfates, hydroxides, nitrates, and/or acetates), a calculated amount of hydroxide (e.g. (NH₄)OH/NaOH) is added to trigger the precipitation of the targeted NMC(OH)₂ (precipitation occurring once the pH of the solution reaches 11). The NMC(OH)₂ can then be removed from the reaction vessel through filtration, dried and annealed with a lithium source (such as LiOH or Li₂CO₃) at 850° C./1-12 hs/100° Ch⁻¹ in either air or oxygen. The remaining solution can be treated in order to remove Li from the solution through the precipitation of the carbonate (via Na₂CO₃ saturated solution). The solution may be disposed of once the Li has been extracted. FIG. 39 illustrates the regeneration of an LO material (in particular, NMC532) through both the sulfate exchange and hydroxide routes—either route may be selected as appropriate depending on the materials available and/or other conditions.

For example, Route A may be selected if an XNMC(OH)₂ hydroxide is the target precipitate. The pH can be adjusted to 11 and the XNMC(OH)₂ precipitates out of solution. This precipitate can then be ground with LiOH·H₂O (for example) to form the Li-NMC phase when annealed (e.g. by being heated to 850° C./12 hs/100° Ch⁻¹). Once the mixture obtained after adding the calculated amount of NaOH/NH₄(OH) to the solution has been filtered to remove the precipitate, lithium may be recovered from the remaining liquid, optionally as the carbonate, and the remaining acid solution (containing the sulfates, nitrates, and/or acetates etc.) may be disposed of afterwards. Alternatively, when a sol-gel route is selected, Route B may be selected, removing the sulfate first (by adding the barium acetate to trigger the precipitation of BaSO₄). Once removed, the solution is evaporated and the precipitate is dried. The precipitate is then fired, for example at 350° C./1 h/30° Ch⁻¹, followed by 850° C./12 hs/100° Ch⁻¹.

To practically demonstrate these routes, the Mn-rich ascorbic acid leachate yielded from the EOL cathode material following the experiments described with respect to FIGS. 40 to 42 was used to synthesise NMC 532 via each route. XRD patterns for the resultant NMC 532 are shown in FIG. 44. In both the regeneration of LMO and the formation of NMC, 10% extra pristine Li can be added to leached solutions made from EOL samples as compared to QCR samples to account for lost Li attributed to solid-electrolyte interphase (SEI) formation/degradation.

The PXRD results are shown in FIG. 17. In particular, FIG. 17 shows PXRD data for regenerated spinel (“Spinel Regen”) and upcycled NMC532 made from QCR and EOL leached solutions with the addition of extra metal ions, alongside plots for the initial, untreated, QCR and EOL cathode strips (“QCR-CS” and “EOL-CS”). The key of FIG. 17 is arranged in the same order, top to bottom, as the plots, for ease of reference. FIG. 17 also shows PXRD data for the QCR and EOL cathode strips after the ascorbic acid leaching treatment described above (“QCR-AAT” and “EOL-AAT”), illustrating the increased prominence of the layered oxide peaks in the non-leached material. Cell parameters are shown in Table 3.

TABLE 3
Cell parameters for spinel and NMC532 made
through Ascorbic acid sol-gel route

| | | | | Cell vol. |
|---|---|---|---|---|
| Condition | Phase | a (Å) | c (Å) | (Å³) |
| QCR | Spinel | 8.1952(2) | — | 550.39(4) |
| | NMC532 | 2.85970(6) | 14.2025(8) | 100.586(8) |
| EOL | Spinel | 8.2101(3) | — | 553.40(6) |
| | NMC532 | 2.85699(7) | 14.1943(9) | 100.337(9) |

The results show successful regeneration of the spinel phase (when the leached solution is treated as above without the addition of any extra metals) and successful upcycling of the Li and Mn in the solution to prepare NMC532 (NMC532 was selected in the embodiment described due to relatively high Mn content and relevance in current generation cathode chemistries; it will be appreciated that different NMC compositions could be selected in other embodiments). This shows that the Li and Mn can be recovered relatively easily, and either the original LMO phase regenerated, or the leached materials used as Li, Mn sources in the preparation of NMC and/or other Mn containing materials. Thus, although Mn is not currently considered high value, as research moves towards O-redox cathodes (which are predominately Mn based), this route offers a facile low-cost supply of key elements for the synthesis of these next generation cathodes.

### Regeneration (2808) of Unleached Cathode Strip Material—Experimental

Once the spinel has been successfully removed from the cathode strip, the remaining unleached material can (also) be regenerated. In the embodiment being described, the remaining layered oxide, and more specifically NMC in the particular example being described in detail, in the cathode strip is the material to be regenerated.

For QCR samples, regeneration may be as straightforward as recoating the remaining layered oxide after thoroughly drying the cathode strip as the PXRD data do not indicate any major shifts that would be indicative of extensive delithiation (therefore also conserving binder and carbon). However, most recycling processes operate through a ‘blind’ process without knowledge of the origin of the defect in QCR cells nor the safety processes that may have been implemented before the cells were discarded. Therefore, QCR strips are likely to be treated in the same way as EOL strips.

A common procedure in the literature is to pyrolyse the cathode strip in order to burn off the binder and additive carbon (see e.g. J. F. Paulino, N. G. Busnardo, J. C. Afonso, Recovery of valuable elements from spent Li-batteries, J. Hazard. Mater. 150 (2008) 843-849. doi:10.1016/j.jhazmat.2007.10.048). In order to investigate the stability and subsequent phases formed after pyrolysis, an EOL cathode strip (after ascorbic acid leaching) was heated up to a temperature in which the PVDF is believed to decompose (VT-PXRD shown in FIGS. 18 to 20). A temperature of 400° C. was selected, and PXRD data gathered over a range of temperatures from 100° C. to 400° C. as the strip was heated, at 20° C. intervals. The layered oxides were seen to convert to a mixed (R3H) phase above 220° C., as discussed below. The heat treatment was performed in air. In FIG. 18, the plots are ordered to match the key, with the lowest temperature plot lowest and the highest temperature plot highest.

FIG. 19 is an SEM image of the cathode strip sample used for the variable-temperature analysis for which data are shown in FIG. 18, after the heat treatment was completed. FIG. 20 demonstrates the observed change in composition with temperature, showing a sharp decrease in LO1 and a sharp increase in Li_{0.3}Ni_{0.7}O above 220° C. The results show that the layered oxides start to convert to a new phase at 220° C. until full conversion is achieved by 320° C. This new phase is believed to be a variant of Li_{0.3}Ni_{0.7}O (Trigonal, R3H) and is similar in structure to the layered oxide(s), however, the system shows extensive site mixing of Li and Ni which would result in poor electrochemical activity compared to the ordered layered phase. Therefore, the results suggest potential difficulties in direct high temperature regeneration due to reaction with the decomposition products of the PVDF binder (LiF impurities suggesting F contamination after pyrolysis, unreacted Li₂CO₃ due to the stability of the mixed site phase etc.). This is not unexpected, given that PVDF is now being widely used as a F source in the fluorination of many mixed metal oxide systems.

Therefore, an alternative route to the decomposition of the binder was developed in order to prevent the reaction with the layered oxide cathode. Consequently, hydrothermal treatment of the layered oxide was considered, given that PVDF is known to be decomposed under alkaline hydrothermal conditions (see M. F. Rabuni, N. M. N. Sulaiman, M. K. Aroua, N. A. Hashim, Effects of Alkaline Environments at Mild Conditions on the Stability of PVDF Membrane: An Experimental Study, (2013). doi:10.1021/ie402684b and L. Pagliaro, D. Lowry, Interaction of Polyvinylidene Fluoride (PVDF)-Based binders with strongly alkaline solutions, 29 (2019) 18-32). In addition to the removal of the PVDF binder, it was hoped that this route would allow Li to be reinserted into the layers, hence directly regenerating the layered oxide, as the host structure was seen to remain intact after the initial leaching treatment. However, PXRD results from initial experiments (160° C./1M/12 hs) using LiOH, suggest the formation of an NMC(OH)₂ phase as the major phase rather than the desired regenerated Li-NMC. Given the formation of NMC(OH)₂ it was decided to exchange LiOH for NaOH to see whether the same results could be achieved using lower-cost NaOH. The results (shown in FIG. 21) show that the mixed metal hydroxide can also be obtained using NaOH with no peak shifts that may be indicative of Na intercalation/contamination. A further reduction in the concentration from 1M to 0.5M results in the same hydroxide product. The reaction appears to be stoichiometric (e.g. assuming the layered oxide has a composition of LiNiO₂ and assuming the cathode strip (CS) is completely composed of the cathode material, 0.2 g of CS would require 0.1639 g of NaOH whereas the 0.5M NaOH solution used in the experiments contains approximately 0.2003 g which explains why 0.5M is sufficient to convert NMC into the equivalent hydroxide). Therefore, if the feedstock is known to be purely layered oxides such as NMC and/or NCA, the amount of sodium hydroxide can be calculated precisely, avoiding unnecessary large excess of reagents and thus avoiding waste. The use of a large excess of LiOH, which is common in current lithiating processes, can also be avoided, so conserving reagents.

FIG. 21 shows PXRD results for an EOL cathode strip (EOL-CS) that has undergone the hydrothermal hydroxide (HH) treatment described above with LiOH and with NaOH. 1M LiOH was used, and both 0.5 M and 1 M NaOH were used. A treatment time of 12 hours was used to obtain the data shown in FIG. 21. In alternative embodiments, a shorter treatment time may be used, optionally with a higher treatment temperature. For example a treatment period of greater than or equal to 6, 8, or 10 hours may be used. An upper limit on the temperature may be set based on a melting point of one or more phases of the material.

FIG. 22 shows PXRD results for a timed study showing the loss of the layered oxide (in this case, NMC) phases and appearance of the mixed metal hydroxide with longer treatment times. Time periods of 2, 6 and 12 hours were selected, and a 0.5 M solution of NaOH.

Once the NMC hydroxide (NMC(OH)₂) was obtained, and by assuming a general composition of Ni(OH)₂, stoichiometric amounts of LiOH—H₂O were calculated, measured, ground with the sample, and heated at 850° C. It will be appreciated that Co and Mn are still present in the material—the Ni(OH)₂ was assumed for simplicity of calculation as the relative molecular masses only differ slightly (e.g. NMC111(OH)₂ and Ni(OH)₂ have only a 2% difference in the amount of LiOH·H₂O required across the series ranging from NMC111 to pure Ni). As a small excess is generally added to account for volatility, the assumption therefore holds as the very small difference is covered by the excess. A more precise determination may be made in other embodiments.

The stoichiometric amount of LiOH—H₂O is calculated gravimetrically based on the mass of (dried) NMC hydroxide. The NMC(OH)₂ contains no lithium, so the amount of Li to add is calculated to provide all the Lithium needed for the desired NMC composition—it will be appreciated that the equivalent approach can be applied for other LO compositions, as appropriate. This gravimetric approach therefore provides a simple calculation based on weight during processing, avoiding a need to estimate the Li content in a lithium deficient end-of-life battery material (which would require full dissolution, Inductively Coupled Plasma (ICP) measurements, and/or electrochemical capacity measurements).

Further, this gravimetric approach may allow for pristine/QCR and end of life electrode materials to be treated at the same time, avoiding a need for pre-sorting of materials. Further, as NMC is currently produced commercially using a hydroxide route (as are many other LO materials), this recycling method should easily fit in with pristine manufacturing routes, requiring minimal plant changes (if any).

The resulting PXRD data for the embodiment being described are shown in FIG. 23, showing the QCR and EOL strips after leaching, the hydroxides produced from the HH-treatment and the resulting layered oxide (here, NMC) phases generated after the 850° C./12 hs annealing process. In particular, FIG. 23 shows PXRD data illustrating the QCR and EOL cathode strips after leaching (“QCR-AA Leached” 2301 and “EOL-AA leached” 2302), the hydroxides produced from the HH-treatment (“QCR-OH” 2303 and “EOL-OH” 2304), and the resulting NMC phases generated after the 850° C./12 hs heat treatment (“QCR-Regened” 2305 and “EOL-Regened” 2306). The results show that a phase pure layered oxide was obtained after the heat treatment. The shoulder that was present in the used material prior to treatment has gone, suggesting the successful regeneration of the ordered layered phase. The small graphitic impurity is also removed after the annealing step. SEM-EDX analysis was conducted on the regenerated samples (FIGS. 24 and 25, and data in Table 4, below). FIGS. 24 and 25 show SEM-EDX mapping data for QCR and EOL samples, respectively, both regenerated through the HH treatment described above. The data show a uniform distribution of elements, supporting the hypothesis of successful resynthesis of the layered oxide phase with relatively small particle size.

Elemental analysis, as summarised in Table 4, suggests that the regenerated QCR material has a composition of LiNi_{0.7}sMn_{0.1}Co_{0.1}Al_{0.02}O₂, commonly abbreviated to NMC811-A. The EOL material has a slightly different composition due to the dissolution/leaching of Mn during use of the battery. EDX analysis reveals a composition of LiNi_{0.78}Co_{0.14}Mn_{0.01}Al_{0.07}O₂ which is more reminiscent of materials commonly referred to as NCA. It is speculated that, during cycling, either dissolution occurs or the surface of the layered cathode becomes relatively Mn-rich compared to uncycled pristine materials, therefore making the layered material more susceptible to attack via the specific leaching treatment. The small decrease in Ni and increase in Al may be associated with the initial process to separate the cathode from the Al current collector. In alternative embodiments, alternative milder routes may be used to liberate the cathode strip from the aluminium current collector, therefore potentially reducing Al contamination. Nevertheless, the route of the embodiment being described is advantageous as industry currently synthesises layered cathode materials through a hydroxide/annealing step, therefore allowing this recycling process to become part of, or to supplement, the pristine supply chain.

TABLE 4
EDX analysis of QC-rejected and EOL cathode materials after
the regeneration treatment

| MAP sum Spectrum (QC-Rejected) | | | | | MAP sum Spectrum (EOL) | | | |
|---|---|---|---|---|---|---|---|---|
| Ele- | Weight | Weight | Ra- | Ratio | Weight | Weight | Ra- | Ratio |
| ment | % | % (σ) | tio | (Total) | % | % (σ) | tio | (Total) |
| Ni | 36.47 | 0.09 | 8.0 | 0.78 | 23.88 | 0.08 | 5.34 | 0.77 |
| Mn | 5.03 | 0.03 | 1.1 | 0.1 | 0.22 | 0.02 | 0.05 | 0.01 |
| Co | 4.58 | 0.05 | 1.0 | 0.1 | 4.47 | 0.04 | 1.00 | 0.14 |
| A1 | 0.71 | 0.01 | 0.2 | 0.02 | 2.31 | 0.01 | 0.52 | 0.07 |

Of note is the lack of fluoride impurities in hydro-regenerated samples when compared with direct-solid state regenerated samples. In order to evaluate whether the F had been retained in the filtrate obtained after the HH treatment (i.e. the waste product remaining after the regenerated solid phase is formed and extracted), this was evaporated and characterised with PXRD and SEM-EDX. The results, shown in FIGS. 26 and 27, indicate the presence of Na₂CO₃ and NaF in the precipitate obtained after evaporating the hydrothermal filtrate. This suggests that the hydroxide treatment has two additional benefits: 1) the hydroxide treatment decomposes the PVDF binder, therefore reducing the likelihood of fluorine contamination in the resultant NMC samples (or equivalently for any LO samples); and 2) Na₂CO₃ is generated as a by-product which can be used to precipitate Li from the solution as Li₂CO₃—in the embodiment being described, filtrates from multiple treatment batches were combined before precipitating Li from the solution in order to have enough Li to meet the solubility threshold. In other embodiments, such as larger-scale batch processes, the hydrothermal filtrate from a single treatment batch may be treated this way, without combination.

The hydrothermal filtrate contains Li that was originally in the layered oxide—the amount may vary depending on age of cathode strip (and in particular on cycling history of the cathode strip), as some Li is lost during cycling due to SEI formation on the surface of the electrodes. As the electrodes have been washed thoroughly before recycling, this Li is, unfortunately, generally lost.

As the remaining Li that was originally in the layered oxide of the battery material EOL may still be present in the hydrothermal filtrate (as lithium carbonate), this lithium may be retrieved as described and used in the regeneration, so further reducing the amount of pristine lithium to be added. Embodiments described herein therefore include a combined phase selective/direct recycling approach to recycle mixed-phase battery electrode materials, such as the blended LMO:LO cathode strips used in early electric vehicles. The skilled person would appreciate that the specific examples detailed herein can easily be adapted to other Mn-containing electrode material phases.

The combined approach for dealing with blended electrodes possesses a number of advantages, both for the individual stages and for the synergetic benefits of the whole combined process. In particular, the leaching treatment developed can be used to avoid complete dissolution of all components into a single solution, which then requires the challenge of lengthy analysis and separation of the complex resultant mixture. Instead, separated waste streams (e.g. for LMO and for LO) are produced, which allows for less complex regeneration/remanufacture processes, therefore adding value to the recovered metals by simplifying the process. By way of example of this, FIG. 30 illustrates leaching of a simulated mixed cathode batch using conditions optimised for LMO removal. In particular, NMC 532, LMO, and LFP were synthesised and FIG. 30 illustrates X-ray diffraction patterns for these: (a) NMC 532, (b) LMO, (c) LFP. These materials were then mixed together in a 1:1:1 molar ratio, and plot (d) illustrates the X-ray diffraction pattern for the mixture. The mixture was then heated to 70° C. in a 1.25 M ascorbic acid solution for a period of ten minutes, with a S:L ratio of 1:20. X-ray diffraction plot (e), for the mixed sample after this leaching treatment, shows the removal of spinel and NMC532 (a few very minor peaks remaining suggest a slightly longer treatment time may be required to fully remove the NMC), leaving the LFP intact. This demonstrates selectivity regarding LiFePO₄ (LFP) and the manganese-containing (NMC532/LMO) cathodes—the manganese-containing oxides are leached whilst the phosphate is unleached—showing that the approach disclosed herein could be used for cathode mass from a mixture of cell chemistries. Further, the separated out LFP material may then itself be regenerated, e.g. by solid state grinding with a lithium source followed by annealing, or exchange using a Li-containing solution (e.g. by reflux, or hydrothermally). For example, LFP cathodes may be regenerated through the following routes:
LFP may be ground with a lithium source e.g. Li₂CO₃, LiOH and annealed at temperatures between 500-900° C. to regenerate the cathode;
LFP may be treated hydrothermally in the range of 100-220° C. for 1-12 hs to replenish lost Li using sources such as LiOH/LiNO₃ or other soluble lithium sources;
LFP may be treated via reflux in a lithium containing solution (e.g. 1-4M LiOH) in the range of 70-150° C. for 1-24 hours;
LFP may be regenerated through a low temperature molten salt route e.g. LiNO₃ at ˜260° C. for 1-12 hours.

The approach described also allows the use of inorganic acids to be avoided if desired, by providing effective alternatives.

Turning to the resynthesis of a leached material from the leachate, or equivalently the synthesis of a new phase using the leachate (e.g. with added metal ions), the approach described herein includes gravimetrically determining the amount of the leached phase in the leachate, so allowing only the exact amount of Li needed to be added, amongst other reagents, so providing a more precise method with lower reagent costs (in particular, it will be appreciated that concentrated LiOH is currently relatively expensive). The selective leaching provided by the leaching treatment improves the accuracy of this simple gravimetric determination, so a synergetic benefit is therefore offered when the leaching process and the leachate recycling process described above are used together. Less diagnostic testing may therefore be needed to accurately determine reagent ratios needed, so reducing overheads.

In addition to the recovery and reuse of the leached phase (LMO), this leaching process also allows for the direct regeneration of the remaining material in the cathode strip (e.g. LO) via a hydrothermal-hydroxide treatment. More specifically, the leaching treatment of various embodiments is designed to reduce, minimise or avoid damage to the remaining phase(s) as compared to previous approaches (both by selection of reagents and by control of treatment time and other parameters), so facilitating the regeneration of the remaining phase(s). A synergetic benefit is therefore offered when the leaching process and the cathode strip/unleached electrode material regeneration process described above are used together.

It is noteworthy that the remaining, unleached, cathode strip material (e.g. LO) may not necessarily possess the same elemental composition as that material in the original electrode due to degradation reactions (a truth commonly overlooked in recycling literature, with many researchers assuming that end of life cathode strips contain the same LO (e.g. NMC) composition as the pristine electrode, in the same ratios, and that the layered phase does not transform during treatment). This will of course have implications when an electrode is being considered for direct recycling. This study has therefore characterised the material throughout the various treatment processes in order to optimise treatment conditions.

Turning back to the hydrothermal-hydroxide (HH) treatment of the cathode strip, an advantage of the process described herein is the decomposition of the PVDF binder, which therefore prevents fluorine contamination in the resultant product. A further benefit of the hydrothermal-hydroxide route is that the by-product, Na₂CO₃, formed during decomposition can be used as a precipitation agent to retrieve Li from extracted solutions.

To summarise, embodiments described herein have the potential to recycle a large proportion of currently used cathode materials (e.g. LMO/blended phases) and future cathode materials (e.g. high Ni—content NMC and/or NCA phases) by exploiting the relative solubilities of the transition metals in aqueous media. Electrochemical data indicates the materials cycle well after regeneration (for example showing ˜150 mAh g⁻¹ cathode performance for NMC532 made through this route).

FIG. 33 provides an example recycling process 330 incorporating various embodiments described herein, as applied to an LMO/NMC blended cathode strip. This process 330 is provided by way of example only, and is not intended to be limiting. In particular, any suitable LO may be substituted for the NMC mentioned.

Steps 331 are preparation of the cathode strip, prior to the leaching treatment 332. In the embodiment shown, the preparation 331 includes manual disassembly of the Li-ion cell, and removal of the aluminium current collector by treatment with sodium hydroxide. Other suitable preparation steps 331 may be used in other embodiments—for example physically delaminating the current collector instead of dissolving it, and/or mechanically shredding and sorting cells in place of manual disassembly. In the embodiment shown, the NaOH treatment to remove the current collector was performed using a 10 wt. % NaOH solution at 70° C., for a time period sufficient to allow the mixture to stop effervescing (so indicating complete removal).

Step 332 is the leaching treatment 332. In the embodiment shown, the selected leaching treatment 332 is performed using a 1.25 M ascorbic acid solution (10 ml per 0.5 g of cathode strip), at 70° C. A treatment time of ten minutes was used for used/EOL cells, whereas a treatment time of 5 minutes was used for QCR cells. It is noted that a shorter treatment time may be used to obtain the same results if more acid is used—for example a 3 minute treatment time instead of 5 minutes if 20 ml of acid solution is used instead of 10 ml.

Following the leaching treatment 332, two separate products remain—a leachate solution containing LMO and what is left unleached of the cathode strip, containing a layered oxide (and more specifically, NMC in this example).

The leachate solution may be directly regenerated 333 to reform the initial LMO. For this spinel regeneration step 333, the leachate solution may simply be heated to a relatively high temperature, e.g. 700° C., for a period of around 12 hours, optionally with a heating and cooling rate of around 100° Ch⁻¹. Optionally, the leachate may be evaporated and dried at 150° C. overnight to form a precipitate which is then retrieved and ground for the higher-temperature annealing process. Alternatively, the leachate may be allowed to dry during the process of heating to temperature, rather than as a separate step.

Additionally or alternatively, some or all of the leachate solution may be used to form 334 a different phase, such as NMC, instead of regenerating the original spinel phase. For this process 334 of forming a new phase from the leachate, a gravimetric determination of how much LMO is in the leachate solution may first be performed; for example by drying and weighing the cathode strip—the mass lost from the cathode strip is taken to be the mass of LMO in solution. Metal ions, more particularly in the form of metal sulfates in the example shown, are then added 334 to adjust the ratio of metals to that of the desired phase (e.g. NMC111).

Two different routes 334a, 334b for forming 334 a desired NMC phase are shown in FIG. 33.

In the first route 334a, the sulfates are removed by mixing the leachate solution with a solution of calculated quantities of Lithium Carbonate and/or Barium Carbonate in acetic acid. 40-80 ml of acetic acid was used in the example described. Different volumes and/or acids may be used in other embodiments. Adding this acetic acid solution to the leachate triggers the formation of a Barium Sulfate precipitate, which can be removed by filtration. NMC can then be synthesized 334a from the solution by evaporating off the solvent (e.g. by dwelling at 150° C.), grinding the resultant solid, and then heating the material, for example dwelling at 850° C. for 12 hours. A lithium source such as hydrous lithium hydroxide may be added at the grinding stage if no Li source, or insufficient lithium, was added at the acetic acid stage.

In the second route 334b, after the metal ratio has been adjusted 334, sodium hydroxide (and/or ammonium hydroxide) may be added 334b instead of using an acetic acid solution. The amount of NaOH (and/or of NH₄(OH)) added may be stoichiometrically calculated, and may neutralise the ascorbic acid and further adjust the pH to around 11. The addition of NaOH (or another suitable OH-source) causes the precipitation of the NMC(OH)₂. After the NMC(OH)₂ has been removed, lithium carbonate can be precipitated out of solution, e.g. using a saturated Na₂CO₃ solution—this material (Li₂CO₃) may be used as a lithium source for subsequent reactions.

The other product of this second route 334b is NMC(OH)₂. The change in pH triggers the precipitation of the targeted NMC(OH)₂. This NMC hydroxide can then be treated with a lithium source (such as hydrous lithium hydroxide, optionally generated from the precipitated out lithium carbonate), optionally by drying and grinding it with the Li source, and then heating the resultant mixture to 850° C. for a period of 12 hours. For example, the precipitate may be filtered, washed and dried before annealing with a lithium source (such as LiOH or Li₂CO₃) in air/oxygen at a temperature of 850° C./1-12 hs at a rate of 100° Ch⁻¹. This may be referred to as a high temperature (HT) process 334b due to the relatively high temperature used. In the embodiment being described, a stoichiometric amount of solid LiOH·H₂O was calculated and used in the solid state reaction.

Separately, following the leaching 332, the remaining, unleached, cathode strip material is removed from the leachate (e.g. by filtration). This may be dried and weighed to facilitate calculation of the amount of spinel lost to the leachate. This unleached, cathode strip material can then be recycled 335; two recycling routes 335a, 335b for the strip are shown in FIG. 33.

In the first 335a, which may be particularly suited to QCR cathode strips (i.e. strips which have failed the quality assurance test before going into use, therefore which have not suffered degradation over a lifetime of cycles), or other early-life strips, the NMC (or other LO material, in other examples) is directly recycled 335a, for example by being re-cast, without the addition of any new material or reagent.

In the second route 335b, the NMC (or other LO material, in other examples) is treated 335b so as to form NMC hydroxide, and the NMC is then re-formed, with addition of a lithium source. This may provide replacement lithium for that lost in use to degradation processes, as well as ensuring that any undesired phase changes in the material are removed. In the example 335b shown, the cathode strip material is heated to a temperature of 160° C., at which temperature it dwells overnight (ON; around 12 hours), with 1 M LiOH so as to form NMC hydroxide. In the embodiment shown, the mass of remaining, unleached cathode strip material (NMC/PVDF and carbon black) after the leaching treatment 332 was 0.1 g, and this was treated with 10 ml of 1 M LiOH—the LiOH was exchanged for NaOH (0.5 and 1M solutions) in other embodiments tested.

The NMC hydroxide is then treated as described above for the NMC hydroxide generated from the leachate so as to re-form NMC. More generally speaking, for LOs which may not be NMC, the mixed metal hydroxide is then treated as described above for the mixed metal hydroxide generated from the leachate so as to re-form the layered oxide.

It will be appreciated that not all steps may be performed in all embodiments, and that details of the steps used may be adapted as described herein, limited only by the scope of the appended claims.

1-28. (canceled)

29. A method of selectively leaching one or more manganese-containing phases from a mixed-phase battery electrode material, the method comprising:
treating the mixed-phase battery electrode material with a solution of an acid, the acid acting as both a leaching agent and a reducing agent, so as to form a manganese-containing leachate whilst leaving at least one phase of the battery electrode material unleached, wherein the acid has a pKa greater than or equal to −2.

30. The method of claim 29, wherein the mixed-phase battery electrode material is a cathode material from a sodium— or lithium-ion battery having a blended cathode.

31. The method of claim 29, wherein the acid is at least one organic acid.

32. The method of claim 29, wherein the acid has a pKa in the range from 2 to 12.

33. The method of claim 29, wherein the acid is ascorbic acid and the acid solution is an ascorbic acid solution with a molarity in the range from 0.25M to 1.5M.

34. The method of claim 29, wherein the treating of the electrode material is arranged to leach out at least substantially only phases in which manganese makes up at least 20% of the transition metal content.

35. The method of claim 29, wherein the electrode material is or comprises a blended cathode strip of LMO and a layered oxide, and wherein the treating of the electrode material is arranged to selectively leach out the LMO whilst leaving the layered oxide at least substantially intact.

36. The method of claim 29, wherein the treating of the electrode material comprises exposing the electrode material to the acid for a period of less than ten minutes.

37. The method of claim 29, wherein the treating of the electrode material comprises exposing the electrode material to the acid for a longer time period when treating electrode material from an end-of-life (used) battery than when treating electrode material from a quality-control rejected new battery.

38. The method of claim 29, wherein the treating of the electrode material is performed at a temperature of between 20° C. and 90° C.

39. The method of claim 29, wherein the electrode material comprises at least one unshredded cathode strip.

40. The method of claim 35, wherein the method further comprises re-generating an LMO phase from the leachate, the re-generating comprising:
drying the leachate so as to form a precipitate;
grinding the precipitate; and
annealing the ground precipitate in air or another oxygen-containing atmosphere.

41. The method of claim 29, wherein the electrode material comprises LMO or NaMO which is leached by the acid solution, and the method further comprises generating a target XNiₓMn_{y}Co_{z}O₂ (XNMC) phase from the leachate, where X is at least one of Li, Na, from the leachate, the generating comprising:
gravimetrically determining the amount of leached LMO or NaMO in the leachate, and, based on the gravimetrically determined amount of leached LMO or NaMO:
calculating a molar amount of a cobalt- and nickel-containing sulfate, M(SO₄)—nH₂O (where M=Co and Ni), required to obtain the target XNMC composition from the leachate; and
calculating a molar amount of a carbonate or hydroxide of X required to obtain the target XNMC composition from the leachate;
combining the calculated amount of M(SO₄) nH₂O with the leachate;
adding a molar amount of a soluble source of a cation selected to trigger the precipitation of a sulfate, so as to remove the sulfate from the leachate solution, the molar amount to add being calculated from the molar amount of M(SO₄) nH₂O and the Co:Ni ratio of M to the leachate solution;
drying the leachate solution so as to form a precipitate;
grinding the precipitate with the calculated amount of a carbonate or hydroxide of X; and
annealing the ground material in air or another oxygen-containing atmosphere.

42. The method of claim 29, wherein the electrode material comprises LMO or NaMO which is leached by the acid solution, and the method further comprises generating a target XNiₓMn_{y}Co_{z}O₂ (XNMC) phase from the leachate, where X is at least one of Li, Na, from the leachate, the generating comprising:
gravimetrically determining the amount of leached LMO or NaMO in the leachate, and, based on the gravimetrically determined amount of leached LMO or NaMO:
calculating a molar amount of a soluble source of cobalt and nickel required to obtain the target XNMC composition from the leachate; and
calculating a molar amount of a carbonate or hydroxide of X required to obtain the target XNMC composition from the leachate;
combining the calculated amount of the soluble source of cobalt and nickel with the leachate;
adding an OH⁻ source until a precipitate is formed;
drying the precipitate;
grinding the precipitate with the calculated amount of the carbonate or hydroxide of X; and
annealing the ground material in air or another oxygen-containing atmosphere.

43. The method of claim 42, wherein the amount of the hydroxide added to form the precipitate is the amount of the hydroxide required to bring the solution pH to 11.

44. The method of claim 29, further comprising:
gravimetrically determining an amount of material lost from the mixed-phase battery electrode material into the leachate; and
adding a stoichiometric amount of one or more reagents to the leachate to introduce desired metal cations, so as to generate a desired battery cathode material.

45. A battery material regeneration method for resynthesizing a layered oxide with a composition of XNiₓMn_{y}Co_{z}O₂ (XNMC) or XNiₓCo_{y}Al_{z}O₂ (XNCA) from a battery cathode, where X is Na, Li, or a mixture of the two, the method comprising:
obtaining an XNMC- or XNCA-containing electrode material from the battery cathode;
combining the material with an OH⁻ source, and heating the mixture to form a precipitate of NMC(OH)₂ or NCA(OH)₂, as appropriate, with X going into solution;
extracting and drying the NMC(OH)₂ or NCA(OH)₂ precipitate;
grinding the precipitate with a gravimetrically-determined stoichiometric amount of a carbonate or hydroxide of X; and
heating the resultant powder to resynthesize XNMC or XNCA.

46. The method of claim 45, wherein sodium hydroxide is used, and wherein the sodium hydroxide is provided as an aqueous NaOH solution with a molarity in the range from 0.5 M to 1 M.

47. A lithium-ion and/or sodium-ion battery recycling method comprising:
obtaining battery electrode material, the battery electrode material comprising multiple phases at least one of which is manganese-containing;
treating the battery electrode material with a solution of an acid with pKa greater than or equal to ˜2, the acid acting as both a leaching agent and a reducing agent so as to form a manganese-containing leachate whilst leaving at least one phase of the battery electrode material unleached,
wherein the battery electrode material is exposed to the acid solution for a period of less than twenty minutes;
draining off the leachate; and
regenerating at least one unleached phase.

48. The method of claim 47, wherein the unleached phase is a layered oxide, and wherein the regenerating the unleached phase comprises:
forming a hydroxide of the unleached phase;
grinding the hydroxide of the unleached phase with a stoichiometric amount of LiOH H₂O for a Li-ion battery material, or NaOH H₂O for a Na-ion battery material; and
heating the resultant powder to resynthesise the original phase.
